(19) United States
(12) Patent Application Publication
(10) Pub. No.: US 2026/0298192 A1
(43) Pub. Date: Oct. 1, 2026

(54) RECIPROCATING OSCILLATING ENERGY HARVESTER

(71) Applicant: North Carolina State University, Raleigh, NC (US)

(72) Inventors: Saurabh Agrawal, Raleigh, NC (US); Andre Peter Mazzoleni, Raleigh, NC (US)

(21) Appl. No.: 19/629,805

(22) Filed: Mar. 26, 2026

Related U.S. Application Data
(60) Provisional application No. 63/777,980, filed on Mar. 26, 2025.

(51) Int. Cl. F03B 13/18

(52) U.S. Cl. CPC F03B 13/1865; F03B 13/188; F05B 2220/706; F05B 2240/97

(57) ABSTRACT

Various examples are provided related to reciprocating oscillating energy harvesters. In one example, a reciprocating oscillating energy harvester includes an energy converter; a tether engaged with the energy converter; and a drag body coupled to an end of the tether. The drag body can adjust force applied to the tether by changing surface area or profile of the drag body within a fluid flow, where the energy converter oscillates in response to variation of the surface area or profile of the drag body. The energy harvester can include a second drag body coupled to the tether.

### CROSS REFERENCE TO RELATED APPLICATIONS

This application claims priority to, and the benefit of, U.S. provisional application entitled “Reciprocating Oscillating Energy Harvester” having Ser. No. 63/777,980, filed Mar. 26, 2025, which is hereby incorporated by reference in its entirety.

### BACKGROUND

With the global energy demand expected to grow 25% by 2040, the need for clean renewable energy sources with low carbon footprints has never been greater. Rivers, tides, and ocean currents provide immense potential for energy harvesting through marine hydrokinetic (MHK) devices. The United States alone holds a total marine energy potential of 368 TWh/year. Modern examples of promising MHK systems, or current energy converters (CEC), for application in rivers, near shore and offshore currents include traditional rotor-based horizontal axis tidal turbines, tethered coaxial turbines, and tethered kite-based systems.

### SUMMARY

Aspects of the present disclosure are related to reciprocating oscillating energy harvesters. In one aspect, among others, a reciprocating oscillating energy harvester comprises an energy converter; a tether engaged with the energy converter; and a drag body coupled to an end of the tether, the drag body configured to adjust force applied to the tether by changing surface area or profile of the drag body within a fluid flow, where the energy converter oscillates in response to variation of the surface area or profile of the drag body. In one or more aspects, the reciprocating oscillating energy harvester can comprise a second drag body coupled to a second end of the tether. The energy converter can comprise a generator wheel engaged with the tether. The drag body can comprise a variable profile body. The drag body can comprise a flap disc. The drag body can comprise an air foil or sail. The drag body can comprise a variable volume body. The drag body can comprise a conical umbrella.

In various aspects, the reciprocating oscillating energy harvester can comprise a second drag body coupled along a length of the tether. The tether can be engaged with a generator wheel of the energy converter and the drag bodies can be coupled to the tether on opposite sides of the generator wheel. The second drag body can be configured to alternate force applied to the tether with the force applied by the drag body. The drag bodies can be separated along the tether by a defined length. The drag body and second drag body can both be the same type of drag body. The drag body and the second drag body can be different types of drag bodies. In some aspects, the energy converter can comprise a drum engaged with the tether. The reciprocating oscillating energy harvester can comprise a generator mechanically coupled to the energy converter. The generator can be mechanically coupled to the energy converter via a drive shaft. The energy converter can be positioned for submerged operation and the generator can be positioned for non-submerged operation. The energy converter can be supported by a mooring shaft. The energy converter can be supported by a vessel.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a Flow-powered Low cut-in speed Oscillating Subsea System (FLOSS) as a trickle charge device operating underwater, in accordance with various embodiments of the present disclosure.

FIGS. 2A-2C illustrate an example of a FLOSS proof of concept design, in accordance with various embodiments of the present disclosure.

FIGS. 3A and 3B illustrate examples of maximum theoretical mechanical power vs flow speed, in accordance with various embodiments of the present disclosure.

FIG. 4 illustrates examples of variable volume body shapes in their high drag and low drag orientations, in accordance with various embodiments of the present disclosure.

FIG. 5 illustrates examples of variable profile body shapes in their high drag and low drag orientations, in accordance with various embodiments of the present disclosure.

FIGS. 6A and 6B illustrate an example of a fabricated FLOSS setup, in accordance with various embodiments of the present disclosure.

FIG. 7 illustrates an example of a tether redirection diagram, in accordance with various embodiments of the present disclosure.

FIG. 8 illustrates an example of a hydrodynamic faring subsystem, in accordance with various embodiments of the present disclosure.

FIG. 9 illustrates an example of an electrical system diagram, in accordance with various embodiments of the present disclosure.

FIG. 10 is a table of variable profile bodies specifications for testing, in accordance with various embodiments of the present disclosure.

FIG. 11 includes images showing variable profile drag bodies during spool-out stroke operating in the water tunnel, in accordance with various embodiments of the present disclosure.

FIG. 12 includes images showing tether and body attachment setup during water tunnel testing with a flat plate and cage, and a 60-degree cone, in accordance with various embodiments of the present disclosure.

FIG. 13 illustrates translation of a cone and flat plate in flow, in accordance with various embodiments of the present disclosure.

FIG. 14 illustrates an example of a raw data comparison of measured electrical power, flywheel RPM, and system torque for a symmetric tapered airfoil for varying flow speeds, in accordance with various embodiments of the present disclosure.

FIG. 15 illustrates an example of maximum generated power, average power, and cycle time vs electrical load for a 60-deg cone for varying flow speeds, in accordance with various embodiments of the present disclosure.

FIG. 16 illustrates an example of measured average drag vs electrical load for a 60-deg cone for varying flow speeds, in accordance with various embodiments of the present disclosure.

FIG. 17 illustrates an example of a raw data comparison of measured electrical power, flywheel RPM, and system torque for a flat plate for varying sizes, in accordance with various embodiments of the present disclosure.

FIG. 18 illustrates an example of maximum generated power, cycle time, and average power vs load resistance for a 60-deg cone for varying sizes, in accordance with various embodiments of the present disclosure.

FIG. 19 illustrates an example of measured average drag from a 60-deg cone load resistance for a spool-out run at 0.7 m/s flow, in accordance with various embodiments of the present disclosure.

FIG. 20 illustrates an example of a comparison of maximum power generated between a 60-degree cone and a flat plate at 0.7 m/s flow speed, in accordance with various embodiments of the present disclosure.

FIG. 21 illustrates an example of a comparison of measured average drag vs load resistance between the 60-degree cone and the flat plate at 0.7 m/s flow speed, in accordance with various embodiments of the present disclosure.

FIGS. 22A and 22B illustrate examples of FLOSS/MARINER water designs with two drag bodies, in accordance with various embodiments of the present disclosure.

FIG. 23 illustrates an example of a FLOSS/MARINER water design with one drag body, in accordance with various embodiments of the present disclosure.

FIG. 24 illustrates an example of a FLOSS/MARINER water surface design with two drag bodies, in accordance with various embodiments of the present disclosure.

FIGS. 25A and 25B illustrate an example of a drum-based drag body FLOSS/MARINER system, in accordance with various embodiments of the present disclosure.

FIGS. 26A-26D illustrate examples of horizontal and vertical FLOSS/MARINER designs for land and air with two drag bodies, in accordance with various embodiments of the present disclosure.

FIGS. 27A-27B and 28A-28B illustrate examples of FLOSS/MARINER water designs with multiple drag bodies, in accordance with various embodiments of the present disclosure.

FIG. 29 illustrates an example of a FLOSS/MARINER water surface design with weather vane direction control, in accordance with various embodiments of the present disclosure.

FIGS. 30A-30E illustrate examples of drag bodies that change surface area, in accordance with various embodiments of the present disclosure.

FIGS. 31A-31E illustrate examples of drag bodies that change profile, in accordance with various embodiments of the present disclosure.

FIGS. 32A-32D illustrate examples of mooring deployments of FLOSS, in accordance with various embodiments of the present disclosure.

FIGS. 33A-33F illustrate an example of a vessel deployment of FLOSS, in accordance with various embodiments of the present disclosure.

### DETAILED DESCRIPTION

Disclosed herein are various examples related to reciprocating oscillating energy harvesters. A novel fluid kinetic energy conversion device, e.g., MARINER (MArine-based Reciprocating current Energy converteR) or FLOSS (Flow-powered Low cut-in speed Oscillating Subsea System for marine current energy harvesting), can exploit the current flow in near and offshore locations. Reference will now be made in detail to the description of the embodiments as illustrated in the drawings, wherein like reference numbers indicate like parts throughout the several views.

Many MHK systems for ocean energy in development are limited to certain areas of use due to constraints like water depths and low flow speeds. Most river and ocean currents rarely have flow velocities exceeding 3 m/s. For example, the Gulf Stream off the North Carolina coast at a water depth of 75 m has an average current of 1 m/s with a measured range between 0.5 m/s and 2.5 m/s. While turbine-based MHK systems can be effective, they require a minimum cut-in flow speed to operate. To efficiently harvest current energy, tidal stream turbines require at least 2 m/s of flow speed and have an average cut-in speed of 1 m/s. For the purposes of this work, speeds below 1 m/s are considered low flow. Other potential challenges for turbine systems include the impact of noise disturbance on the marine ecosystem and the risk of collision of marine life.

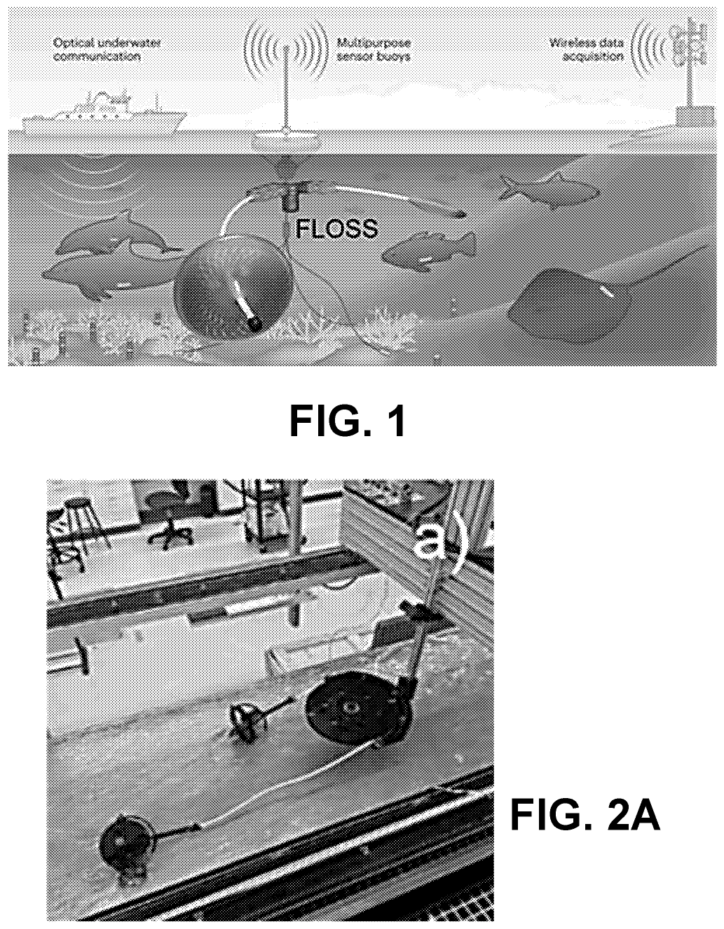

To address these challenges, a novel MHK system named FLOSS (Flow-powered Low-cut-in-speed Oscillating Subsea System) was developed. FIG. 1 is a visualization of an example of FLOSS as a trickle charge device operating underwater. The guiding principle of the system is drag-based propulsion with less than flow speed operation. Initial research on FLOSS was conducted, including modeling efforts to determine feasibility. While the theoretical assessment demonstrated strong potential of the system for application in various flow regimes, including low-flow environments, additional experimental validation to assess the hydrodynamic behavior of the system in a flow regime remains. This work presents a parametric experimental study with the objective of assessing the hydrodynamic response of the drag-based system and assessing the behavior of a tethered drag body translating in various flow speeds.

### Working Principle

The operating principle of the proposed novel system, FLOSS, is based on the motion of a body in a flowing fluid due to drag force. The application of this principle presents an opportunity to tap into low-flow marine environments that remain largely unexploited. Additionally, the concept enables operation in virtually any flow regime as well as surface-level, partially submerged, or fully submerged operations. FLOSS offers tremendous potential as a unique, scalable, low environmental impact current energy harvesting device.

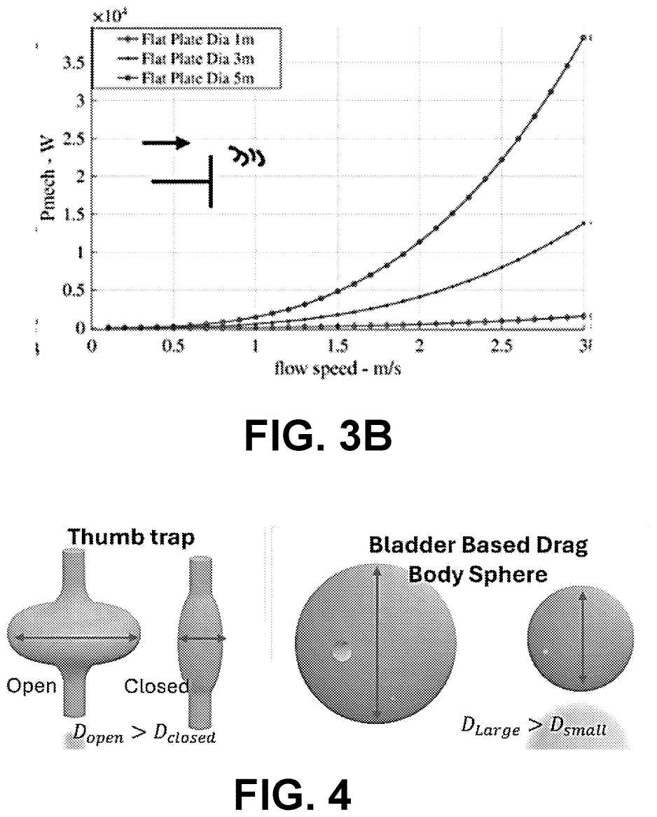

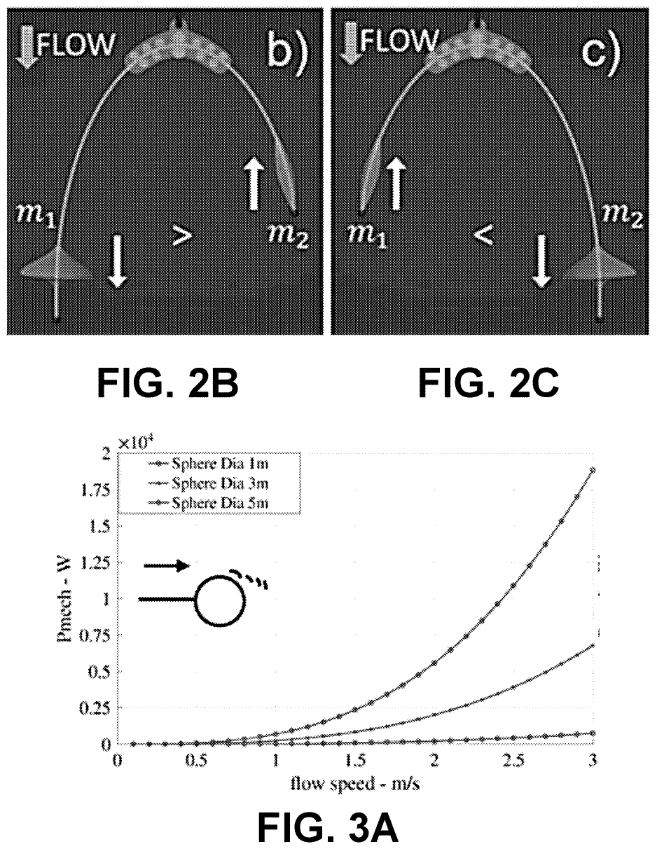

FLOSS utilizes two interconnected variable drag bodies that alter their size and/or shape to generate a variable drag force in a current. By periodically alternating the drag force between the two bodies, a reciprocating motion can be created where the higher drag body moves along with the flow while the second body with the lower drag moves in the opposite direction. FIG. 2A shows an example of a working prototype of the FLOSS system that was used to conduct initial proof of concept testing in a flowing current. FIG. 2B graphically illustrates the FLOSS system with Body 1 open and Body 2 closed. In a free stream flow, when Body 1's size is increased or profile oriented against the flow, the body's drag force becomes higher than that of Body 2, whose size or orientation is simultaneously altered. This results in Body 1, with higher drag, moving in the direction of flow as shown in FIG. 2B, performing a spool out stroke, while the lower drag Body 2 moves in the opposite direction, performing a spool in stroke. FIG. 2C graphically illustrates the FLOSS system with Body 2 open and Body 1 closed. By altering the drag on the two bodies, a reciprocating or “flossing” motion is created.

Initial theoretical work done to simulate the system's behavior showed that the primary factors governing performance and power generation, for a particular shape, are the size of the drag body and the speed of the current. FIGS. 3A and 3B show maximum theoretical mechanical power vs flow speed for a circular flat plate (3A) and a sphere (3B) with increasing diameters. For different shapes of varying drag coefficients, an increase in the flow speed and body size significantly boosts the maximum mechanical power output.

Equation 1 shows that power generated is directly proportional to the relative velocity squared of the moving drag body and the reference surface area. The potential of the two-body FLOSS system to generate power relies on its ability to maximize the difference in drag between the two bodies.

$${P}_{m e c h} = \frac{ρ {V}_{B}}{2} [ {( {V}_{f} - {V}_{B} )}^{2} {S}_{1} {C}_{{d}_{1}} - {( {V}_{f} + {V}_{B} )}^{2} {S}_{2} {C}_{{d}_{2}} ] \qquad ( 1 )$$

C_{d}_{₁} is the coefficient of drag of body 1, C_{d}_{₂} is the coefficient of drag of body 2, p is the density of the fluid, P_{mech} is the theoretical mechanical power, S₁ is the reference area of body 1, S₂ is the reference area of body 2, V_{f} is the freestream velocity, and V_{B} is the velocity of the moving body.

Initial steady state simulations verified that maximizing net drag results in a greater torque that can be applied to a generator, resulting in higher power generation. However, they do not consider the hydrodynamic instability effects that act on a translating body in the flow. The dynamic characteristics of tethered spooling drag bodies, particularly during the spool-out stroke, were insufficiently understood.

### Methodology

A preliminary experimental study is presented focusing on a single tethered high-drag body during the spool-out stroke. The goal of the experiment is to identify the effects of hydrodynamic behavior and stability characteristics of various drag body shapes in their high-drag configurations to assess the influence of size and flow speed on performance. The research aims to better understand the reciprocation of a drag body shape in a flow environment and will help further develop an understanding of the FLOSS system.

Drag Body Classification. For the FLOSS system, the drag bodies can be categorized into two principal classes: (1) Variable Volume Body (VVB) and (2) Variable Profile Body (VPB). The basis for classification is the method of area change, which modulates the hydrodynamic drag and its effect on the body's buoyancy. Both cases are described below.

For the Variable Volume Body (VVB) classification, the hydrodynamic drag can be altered by changing the overall size of the body through a volume change. This change directly affects the projected reference area as well as the buoyancy of the body in the water. Two examples of this type of body are seen in FIG. 4, which shows examples of variable volume body shapes in their high drag and low drag orientations. On the left is a mesh-based flexible design that forms an axisymmetric bulge when contracted, inspired by a finger thumb trap. On the right is a bladder-based sphere that inflates and deflates.

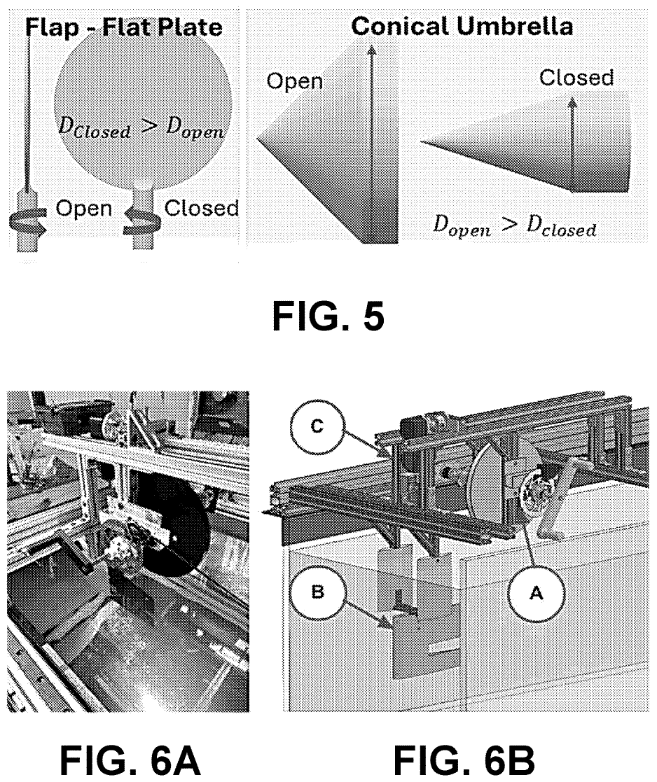

For the Variable Profile Body (VPB) classification, the body can achieve a change in drag by changing the body surface profile with respect to the oncoming flow. One way this can be accomplished is by varying the Angle of Attack (AOA) of the surface. The difference between VPBs and VVBs is that the volume of VPBs remains constant during the profile change operation, allowing the body to maintain a constant buoyancy. FIG. 5 shows examples of VPB shapes in their high drag and low drag orientations. Variable Profile Body designs include, e.g., flap-based designs that incorporate mechanisms to alter the angle of attack, such as flat plates, symmetric airfoil fairings, and asymmetric airfoil fairings. Additionally, VPB designs can include a radial drag modulation configuration, which involves actuating surfaces to influence hydrodynamic drag, such as, e.g., conic umbrellas, round umbrellas, and radial hydro brakes.

For the system, both categories of bodies allow for lower impact on the surrounding environment due to their lower than flow speed operation and lower noise generation with the lack of rapidly moving parts. However, in terms of operation, both drag body classifications offer tradeoffs. The changing volume of VVBs gives the system the ability to alter the buoyancy, providing control over the drag bodies' vertical separation. In contrast, VPB designs offer active control methods via a profile angle change or passive control through asymmetric surfaces inducing lift or side forces, which can be utilized for body separation.

Experimental Setup. The experimental testing for the single drag body was conducted at the North Carolina State University free-surface water tunnel. The test focused on measuring drag force, torque, angular velocity, and power generated by a single drag body moving downstream in flowing water. The water tunnel has an 81.3 cm wide×71.1 cm tall×243.8 cm long rectangular test section where the experiment took place. The tunnel has a flow speed range of 0.0.16 m/s to 0.96 m/s. The designed test rig converts the linear motion of a drag body into rotational motion using a pulley-driven system, enabling mechanical power generation and simultaneous data acquisition. The system uses a series of pulleys to redirect the tether and keep all instrumentation above the waterline, since sensitive electrical components cannot be submerged in water unless they are contained in waterproof containers.

General Operation. The system operates by transferring the drag of a body placed in a flow to a large flywheel via a tether. The experimental system utilized three pulleys for redirection and dry operation. As the drag body moves downstream, the central flywheel begins to rotate. The flywheel is fixed to a stainless-steel shaft, which is coupled to the generator. During each operation, the drag body was allowed to spool out for 1.5 m, the brake was applied, and the manual crank was used to pull the drag body back to the starting position.

Main Shaft and Flywheel Subsystem. FIG. 6A is an image of the fabricated single FLOSS design setup mounted in the water tunnel. FIG. 6B is an isometric view illustrating (A) the main shaft and flywheel subsystem, (B) hydrodynamic fairing subsystem, and (C) load cell subsystem. The main shaft is a 1.27 cm (0.5 in) OD stainless steel rotary shaft. The shaft transfers torsion to the system through braking, drag, and the motor. Made of ABS, the central flywheel has a 30.5 cm (12 in) OD with a V groove for self-realignment of the tether. The size of the Flywheel was maximized for the setup, allowing for the maximum torque to be drawn at lower tensions.

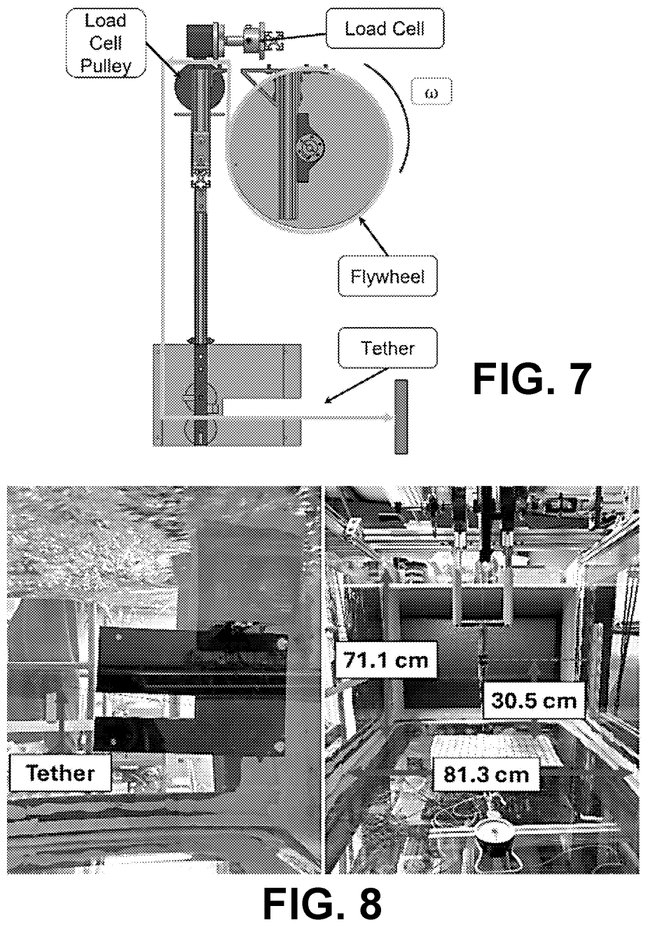

The tether chosen for the system was a braided nylon neutrally buoyant fishing line with a loading capability of up to 45.4 kg (100 lbs) of axial tension. The choice allowed for negligible mass and external force contributions to the moving drag body. The tether is wrapped around the main flywheel and redirected via a series of supporting pulleys to the drag body, as shown in the tether redirection diagram of FIG. 7. As the drag body spools out, a torsional load is imparted to the flywheel, causing rotation. This rotation is transferred to the generator via a central shaft to which the flywheel is fixed. The generator is fixed to a static torque sensor cantilevered off the far side of the tunnel. At the opposite end of the rod, a symmetric handle is fixed to the shaft to help reel in the drag body against the flow. Due to their size, the flywheel and handle hold most of the rotational inertia of the system.

Hydrodynamic Fairing Subsystem. The purpose of the hydrodynamic fairing is to reduce wake-induced turbulence in the flow which would affect the drag shapes. Because the structural beams are cantilevered, exposure to direct flow can also induce oscillation, hence the fairing. To further reduce oscillations, the submerged beams were supported with struts. The submerged pulleys sandwich the tether 30.5 cm above the bottom glass, reducing the potential of it slipping out of the track and positioning the body in the center of the water. The setup for the hydrodynamic faring subsystem used to guide the drag body tether is shown in FIG. 8.

Load Cell Subsystem. The biaxial load cell is cantilevered off the top of the scaffolding. A pulley is mounted off the load cell, which redirects the tether from the central flywheel to the submerged pulleys as seen in FIG. 7. The load cell pulley is positioned such that the tether going from the flywheel around the load cell pulley and to the submerged pulley is collinear, allowing the load cell to read twice the tension in the tether, giving better resolution for the drag measurements.

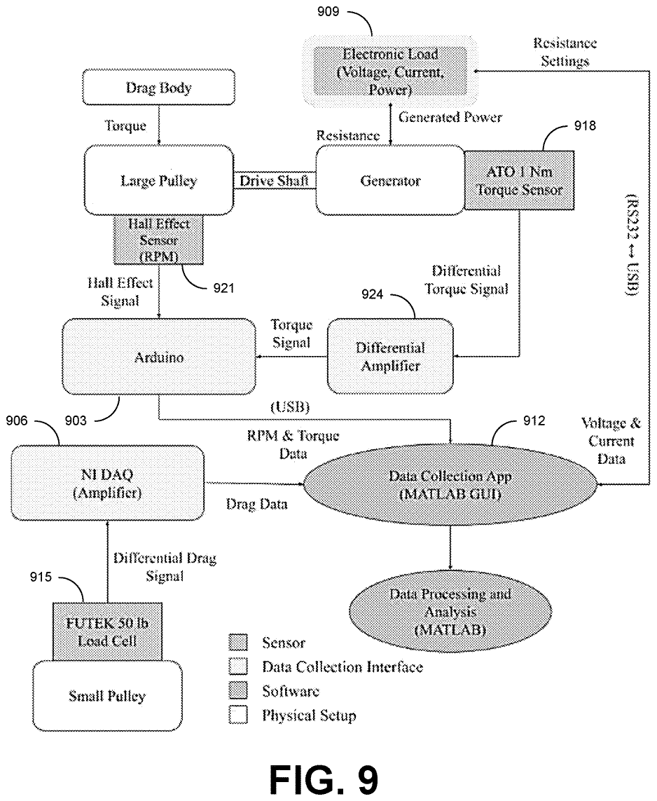

Electrical Experimental Setup. The experimental setup was equipped with a system of data collection interfaces and sensors to collect data on the physical and electrical characteristics of the system. FIG. 9 shows the system diagram of components and signal chains in the electrical experimental setup. As shown in the diagram are the three primary data collection interfaces: an Arduino MEGA 2560 R3 903, a National Instruments DAQ 906, and a B&K Precision 8551 DC Electronic load 909. All data managed by these interfaces was ultimately recorded by a MATLAB App 912. The highlighted blocks on the diagram show the sensors used in the setup, including a FUTEK MBA400 load cell 915, an ATO DYJN-104 torque sensor 918, an A3144 Hall-effect sensor 921 for measuring rotational speed, and the 8551 Electronic Load 909 to collect generator output data. A 12V DC 87 RPM gear motor was selected for use as the generator during testing.

Each component required a signal chain leading to the MATLAB App 912. The ATO torque sensor 918 transmitted a differential signal through an amplifier IC 924, configured with 0 Nm centered around approximately 2.5 V The torque sensor output a 0 V-5 V signal to be converted to torque by the Arduino 903. Rotational speed was determined by detecting a series of magnets on the flywheel using the Hall-effect sensor 921, and the state of the sensor was read by the Arduino 903. Data collected by the Arduino 903 was logged at a frequency of approximately 30 Hz in the MATLAB App 912 through a USB connection. The NI DAQ 906 recorded the differential signal from the FUTEK load cell 915 as voltages. Measured voltages were converted to force measurement in the MATLAB App 912. Table 1 provides the ranges and errors for the sensors. Electrical data from the generator was obtained by polling the 8551 Electronic Load 909 through an RS-232 communication interface using the MATLAB app 912. The resistive load applied by the Electronic Load 909 was controlled programmatically through the same RS-232 interface.

TABLE 1
Range and error of sensors

| | | Non- | |
|---|---|---|---|
| | Capacity | linearity | Calculated |
| Component (units) | Range | (% FS) | Error |
| Load Cell (lb) | 50 | 0.1% | ±0.05 |
| Torque Sensor (Nm) | 1 | 0.05% | ±0.0005 |

Using the discussed sensors, testing was conducted across multiple flow speeds and electrical loading configurations to study system response, including drag, drive shaft torque, and drive shaft rotational speed. The starting free stream velocity of 0.5 m/s was selected with a maximum flow speed of 0.9 m/s. To simulate different power take-off conditions, electrical loading on the DC motor/generator in the form of a resistive load was also applied, and the resulting voltage, current, and power were measured.

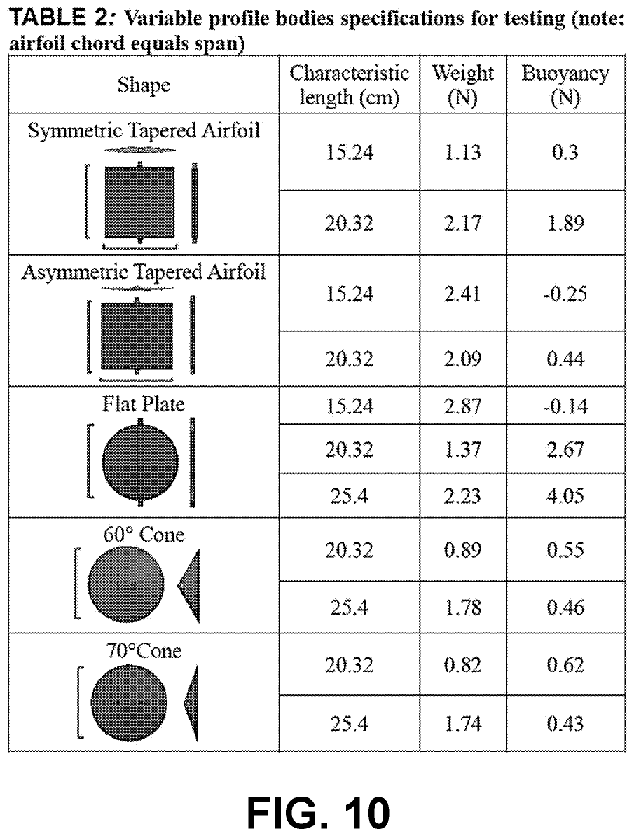

Drag Bodies used for testing. Drag bodies were fabricated to characterize their hydrodynamic behavior in flow. VPBs, such as flat plates, airfoils, and cones, were 3D-printed using ABS and tested in the experiment. As seen in Table 2 of FIG. 10, each shape was made in three sizes: 15.24 cm (6 in), 20.32 cm (8 in), and 25.4 cm (10 in), to observe the effects of scale on hydrodynamic characteristics and power generation. The largest size, 10 in, was chosen to maximize power generation with minimized disturbances from wake propagation at the test section's boundary. The smallest size, 6 in, was chosen such that power generation provided a meaningful comparison.

Note that for clarity, the drag bodies are identified by their nominal imperial sizes (6 in, 8 in, and 10 in). The thickness-to-chord ratio for the symmetric airfoils was 0.10. For a 6 in chord of a symmetric airfoil, the maximum thickness was 0.6 in. The asymmetric airfoil was half of the symmetric airfoil, designed by splitting the symmetric airfoil along its camber line, as seen in Table 2. The aspect ratio (AR) for the airfoil design was set at 1 for simplicity, so that the chord and span were equal.

For testing, flat plates and airfoils were attached to the tether using a cage, allowing for easy adjustment of the angle of attack. Tabs on either side of the shapes fit into holes in the cage, and set screws were used to secure their rotation. A common frame was used for both 8-inch and 10-inch shapes.

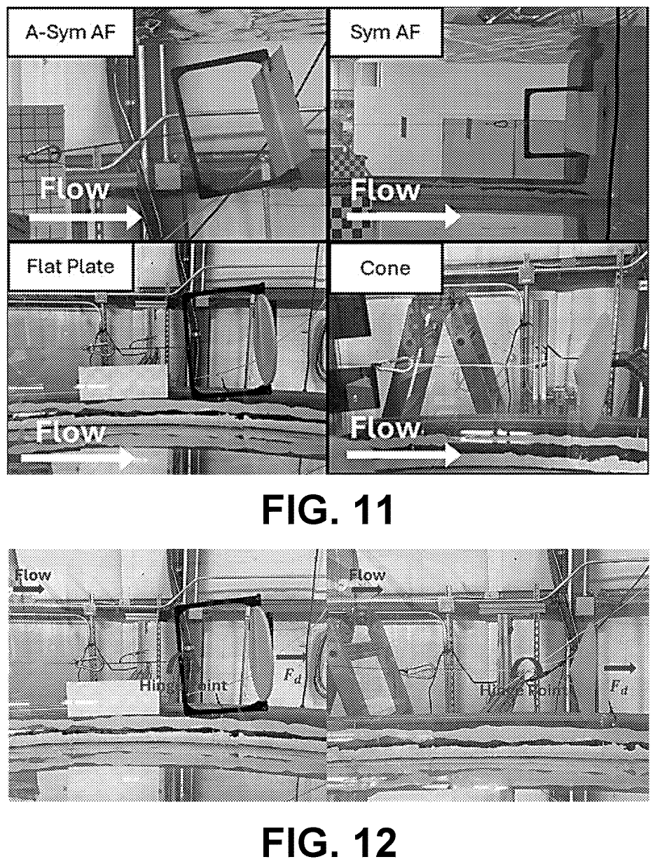

The cones did not use a frame; instead, they had a through hole for a tether loop to be tied directly. FIG. 11 shows the respective variable profile drag body shapes during spool-out stroke testing in the water tunnel. FIG. 12 shows the tether and body attachment setup during water tunnel testing with a flat plate and cage (on left) and a 60-degree cone (on right). A carabiner was used to attach the tether to the shapes for quick interchange during testing, which can be seen in FIG. 12. Before all tests, the buoyancy of each shape assembly was checked, and external adjustments such as added weights or small lightweight foam blocks were used to achieve neutral buoyancy. Table 2 shows the net buoyancy of only the fabricated part and does not take into account the entire assembly.

Spool-out testing began by positioning the shape at the upstream end of the test section and establishing steady flow conditions. The system's brake was then released, allowing the shape to spool out freely with the flow. Once the shape reached the downstream limit of the test section, the brake was depressed, and the shape was reeled back upstream against the flow. This procedure was repeated for each geometry, scale, flow speed, and electrical loading configuration. Table 3 lists each flow speed tested and the corresponding electrical loading values used for the parametric study.

TABLE 3
Water tunnel testing parameters

| Parameter | Values |
|---|---|
| Flow speed (m/s) | 0.5, 0.7, 0.9 |
| Electrical load (Ω) | 50,000; 250; 200; 150; 100; 90; 80; |
| | 70; 60; 50; 40; 30; 20; 10; 1; 0.05 |

### Results and Discussion

Passive stability of drag bodies. During testing, the profile shapes consistently demonstrated stable and repeatable behavior. Among the tested geometries, the flat plate, symmetric airfoil, and asymmetric airfoil demonstrated stable motion during spool-out. The cone shape had considerably more unstable behavior as observed when placed in the flow. The 70-degree cone was highly unstable, exhibiting strong wake-induced oscillations, while the 60-degree cone was relatively more stable during spool-out.

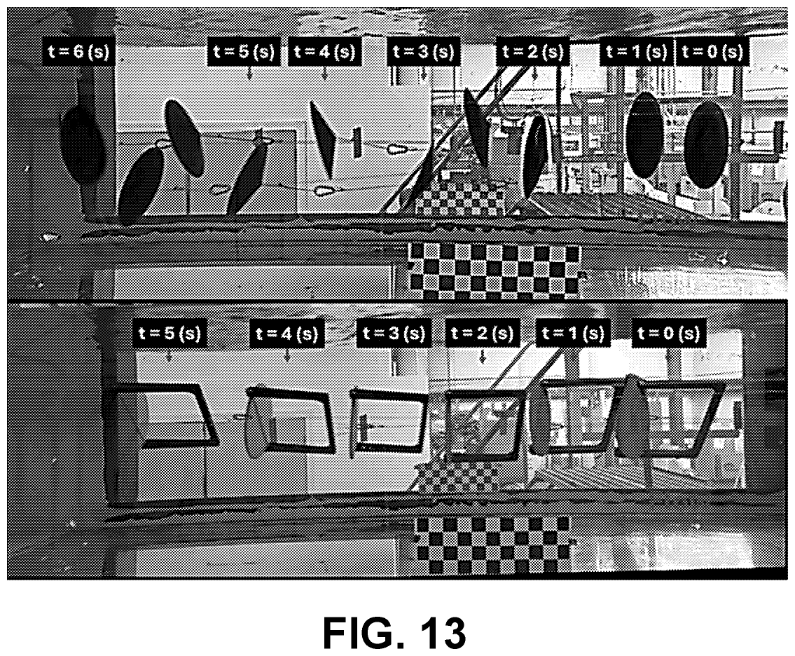

FIG. 13 captures the attitude of the 70-degree cone and flat plate as they spool out in the flow. The top image shows the translation of an 8 in 70 deg cone in 0.5 m/s flow and the bottom image shows the translation of an 8 in flat plate in 0.5 m/s flow. Based on observations, the distance between the resultant drag force and the tether attachment point directly relates to stability during translation. Due to the larger distance between the drag body surface and tether attachment point for the cone shapes, a larger corrective moment arm was able to produce a greater restoring moment and thus increase passive stability. For the 70-degree cone shape, the reduced restoring moment, combined with wake-induced forces, led to increasing imbalance and unsteady motion during spooling, leading to an increase in pitch perturbation and flapping motion.

Performance as a function of flow speed. For the parametric study, multiple runs and iterations were conducted. However, for brevity, only a few examples of the observed data trends are presented in the following plots. The figures below show the experimental data collected during the spool-out stroke, specifically the effect of flow speed on performance.

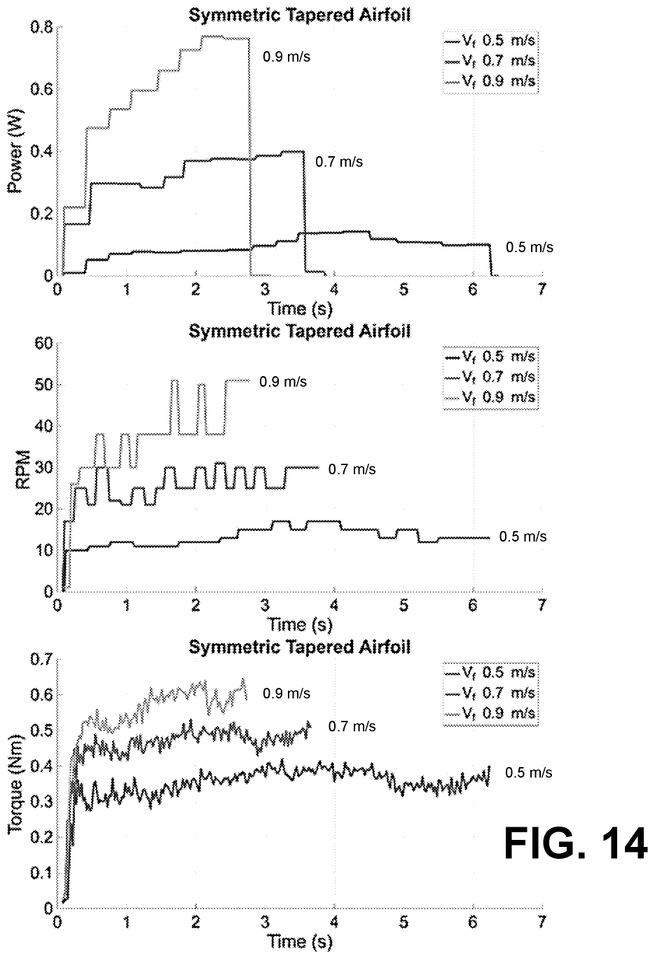

FIG. 14 presents the measured electrical power, flywheel RPM, and system torque over the spooling time domain for an 8 in symmetric tapered airfoil operated with an electrical load of 10 ohm for varying flow speeds. The presented raw data comparison corresponds with the time the drag body starts to move until the shape is stopped at the end of the test section. The data shows there is a clear increase in the overall performance of the spooling out drag body with an increase in flow speed. This can be seen with the electrical power generation, where over 0.7 W was measured at 0.9 m/s flow speed compared to the 0.4 W measured at 0.7 m/s. This result is directly linked with the RPM and torque, and a proportional response can be seen in the plots. The increased flow speed resulted in higher drag, which imparts more torque on the generator, creating more power. It is also seen that there is a ramp-up in the acceleration of the drag body from start to end. At 0.5 m/s, the shape reached a relatively consistent velocity; however, at 0.9 m/s, the shape continues to accelerate for the majority of the run. The higher flow speed has clear advantages because of the shorter cycle time and higher overall power, however low flow speed could be optimal in a situation where a constant velocity and consistent power are preferred.

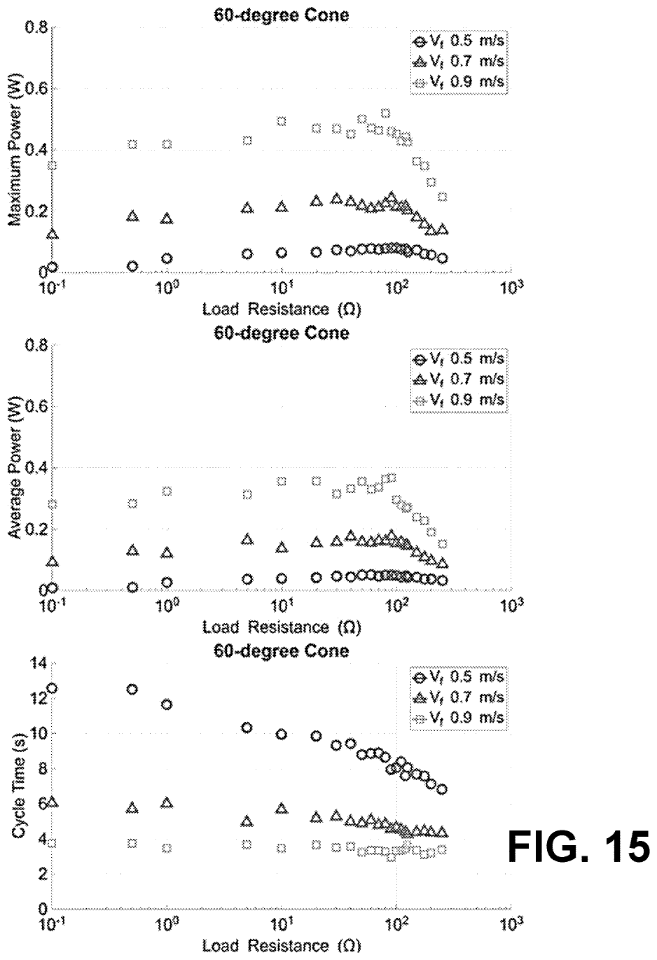

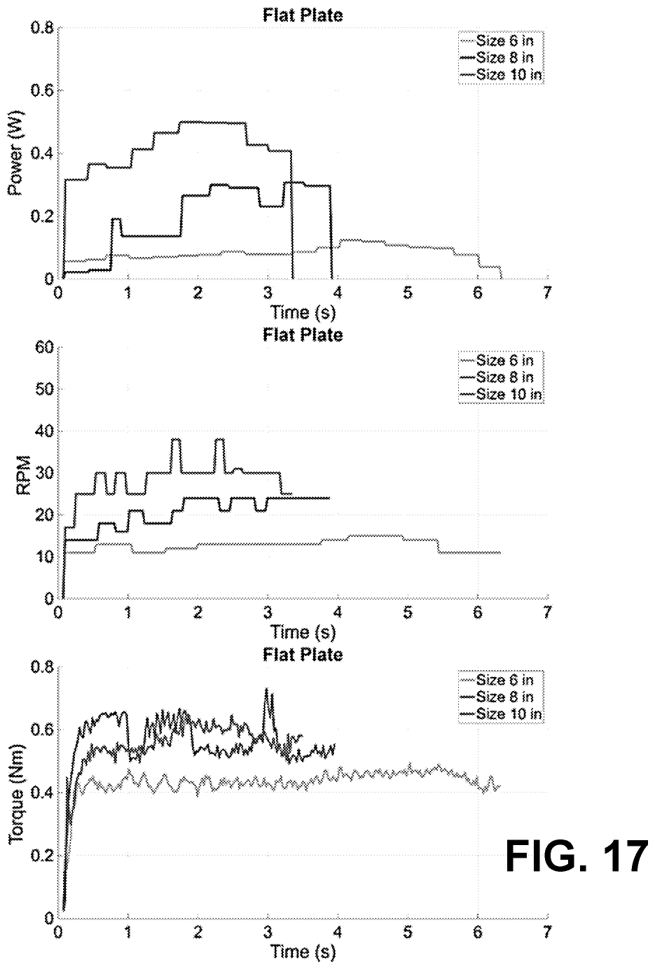

For an 8 in sized 60-degree cone shape, FIG. 15 compares the observed maximum generated power for each iteration, average power generated over a time domain for a given load, and cycle time vs electrical load for varying flow speeds, the average time taken for the translating shape from start to end. As seen from the two power plots, there is a marked increase in power generation with an increase in flow speed for all the tested electrical loads, with a peak maximum and average power measured close to 100 ohms for all three speeds. The power trend shows that as the electrical load is reduced, power generation increases along with cycle time. However, after a certain point power generated reduced with a continued increase in cycle time, indicating the slowing down of the drag body velocity. The lower the electric load greater is the required torque input from the drag body to spin the generator. There is an optimum operating load point to obtain maximum power. Beyond this threshold, the RPM is too low to spin the generator shaft fast enough to get power.

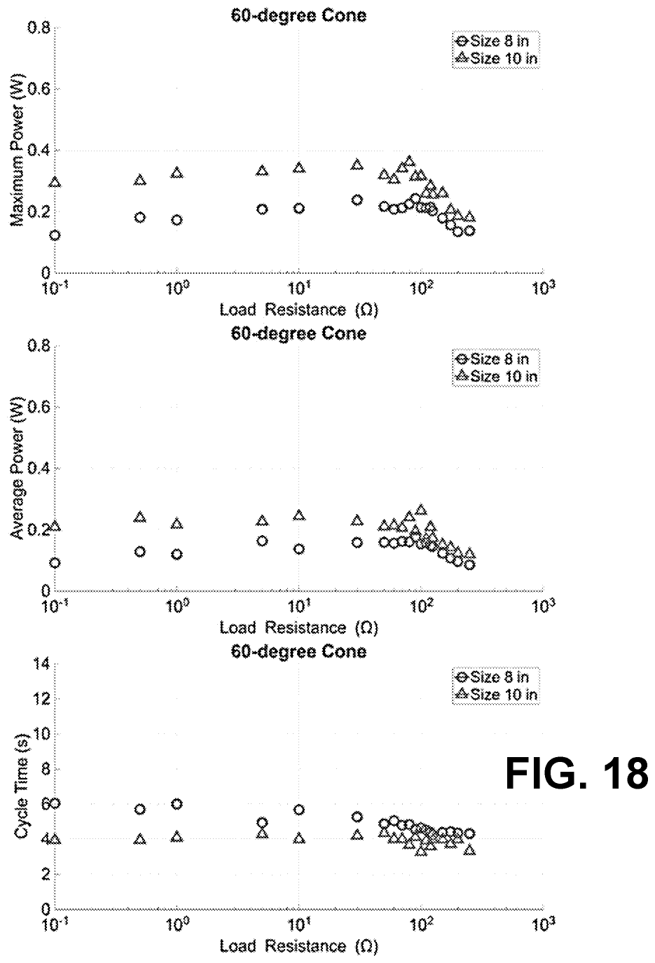

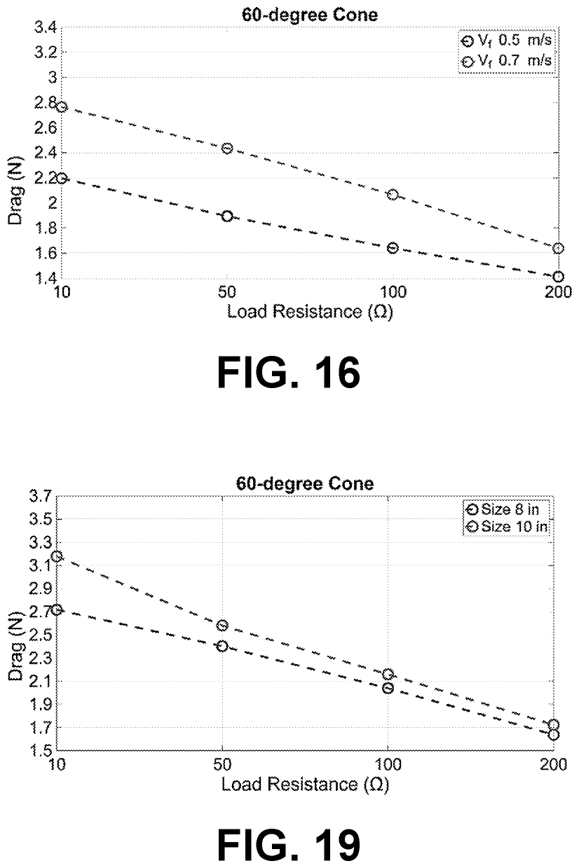

FIG. 16 compares the time-averaged drag measured for each run to the electrical load for an 8 in 60-degree cone for varying flow speeds, with drag increasing with an increase in flow velocity. The body velocity in the freestream is shown to reduce due to the lowering of the electrical load. This causes an increase in the relative velocity of the body, leading to an increase in drag.

Performance as a function of size. FIG. 17 compares the effect an increase in size has on measured electrical power, flywheel RPM, and system torque for a flat plate geometry operated at the same electrical load (1 ohm) for varying sizes at 0.7 m/s flow speed. The power generation plots show that power increases with size, similar to how the power increases with flow speed. Also, it's seen that higher power and larger shape geometry result in higher RPM. The torque plot shows the same trend; however, the distinction between the two larger sizes is less evident. This increase in torque is caused by an increased drag due to a larger surface area, resulting in higher spool-out speeds.

From the trends, there is a ramp-up in the acceleration of the drag body from start to end. For the 6 in geometry, the shape reached a relatively consistent velocity; however, the 8 in and 10 in shapes continue to accelerate for most of the run. The plots show that larger shapes generate more power at a given flow speed, and smaller shapes are able to generate more consistent power over the same spool-out distance.

For a flow speed of 0.7 m/s, FIG. 18 shows the maximum and average generated power as well as the cycle time of a 60-degree cone for varying sizes. The trends observed are similar to those seen for variable flow speeds, where the average power and maximum power increase with a larger shape. Additionally, a larger shape will experience a shorter cycle time. However, it is observed that for the 10 in shape there comes a point where despite the lowering of loading resistance and a corresponding increase in drag as seen in the measured average drag for a spool-out run at 0.7 m/s flow in FIG. 19, the cycle time and power generation remain relatively unchanged. This indicates that larger shapes appear to be less sensitive to loading changes in a distinct operating zone.

From the power plots, it is seen that the peak average and peak maximum power were measured close to a load of 100 ohms for both sizes. This is similar to the results seen in FIG. 15. This indicates that peak power is tied to the loading condition and not size or flow speed. From the measured power, the overall gains in power generation for an increase in size are not as pronounced as those from an increase in flow speed. The effects are such because the relative velocity term is squared in Equation 1, while the surface area is not.

FIG. 19 shows a relationship consistent with FIG. 16, that larger-sized shapes experience higher drag and that drag increases with lower resistive loads. However, flow speed has a greater effect on drag increase than an increase in size. This result shows that for an application in low flow regions, a larger shape will provide a marked improvement in power generation.

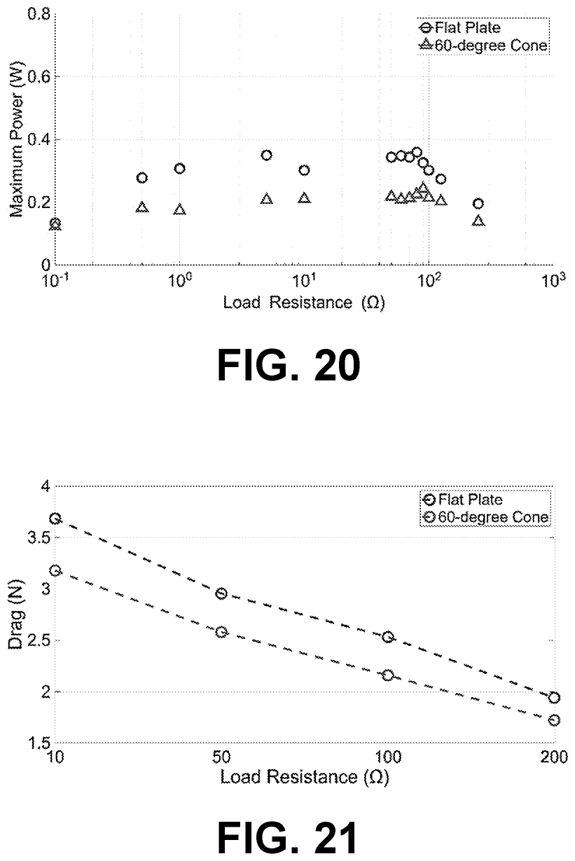

Relative comparison of shape on performance. The results from FIG. 20 show a comparison of the maximum power generated between a 10 in 60-degree cone and a 10 in flat plate at 0.7 m/s flow speed. It is seen that the flat plate generated more power compared to the 60-degree cone. From the literature, it is known that the coefficient of drag for the flat plate is greater than that of the 60-degree cone. This is consistent with the comparison of measured average drag vs load resistance between the 10 in 60-degree cone and the 10 in flat plate at 0.7 m/s flow speed in FIG. 21, which shows that the measured drag for the flat plate was greater compared to the cone. With these observations, it can be concluded that the coefficient of drag plays a large role in shape selection and is an important criterion for better performance.

An experimental investigation was conducted into studying the characteristics of a single tethered high-drag body during spool-out motion. The parametric study involved testing shapes that are classified as a Variable Profile Body in flow speeds up to 0/9 m/s. Building on the prior theoretical work done in simulating the novel FLOSS concept, the goal of this study was to identify the effects of hydrodynamic behavior and stability characteristics of various drag body shapes in their high-drag configurations and to analyze the influence of increasing size and flow speed on performance.

The results obtained from the study demonstrated that in low flow conditions, all tethered drag shape and size configurations produced measurable spool-out motion, confirming the ability to convert current energy into mechanical motion and power generation. The profile shapes consistently demonstrated more passive stability and repeatable spool-out behavior, especially the flat plate, symmetric airfoil, and asymmetric airfoil geometries.

Overall, an increase in both body size and flow speed was found to correspond with increased performance and reduced cycle time. The performance gains observed from a flow speed increase was comparability larger than those of size increase. The maximum power generated by an 8 in size 60-degree cone went from 0.24 W at 0.7 m/s flow to 0.51 W at 0.9 m/s flow, while the 10 in version generated 0.36 W at 0.7 m/s flow speed. This showed that power generated through flow speed increase more than doubled versus the power gained due to a size increase, which led to a 50% rise.

The experimental results demonstrate that tethered drag bodies from the FLOSS concept can operate in the low-flow environment, where power generation and overall performance directly relate to the body size of the system and flow speed. Additionally, shape selection plays an important role as bodies with a higher drag coefficient provide better performance. The findings provide quantitative guidance for future drag body selection and advance the understanding of the tethered drag-based energy concept, laying the foundation for developing and deploying an open water flow system for current energy extraction.

### EXAMPLES

A novel fluid kinetic energy conversion device, e.g., MARINER (MArine-based Reciprocating curreNt Energy converteR) or FLOSS (Flow-powered Low cut-in speed Oscillating Subsea System for marine current energy harvesting), can exploit the current flow in near and offshore locations. For example, a reciprocating oscillating energy harvester can comprise an energy converter and at least one drag body coupled to a tether engaged with the energy converter. The at least one drag body can be configured to adjust force applied to the tether by changing surface area or profile of the at least one drag body within a current flow of a fluid. The energy converter can comprise a generator wheel with a generator connected to the tether via a pulley wheel, spool, clutch or other appropriate mechanism. By increasing the surface area or profile (and thus the drag) of the at least one drag body, the force applied by the at least one drag body to the tether can be increased to exceed a threshold amount, causing the tether to be extended and the spool to be rotated and drive the generator thereby converting the mechanical energy into electrical energy. Reducing the surface area or profile of the at least one drag body causes the force to be reduced, allowing the spool to retract the tether back onto the spool. By controlling the surface area of the at least one drag body, the applied force, and thus the generated electrical energy, can be controlled in a cyclic fashion. By extending the tether around the spool and having drag bodies at both ends of the tether, the applied force can be controlled in a more continuous fashion as will be discussed.

### Underwater (Two Drag Body):

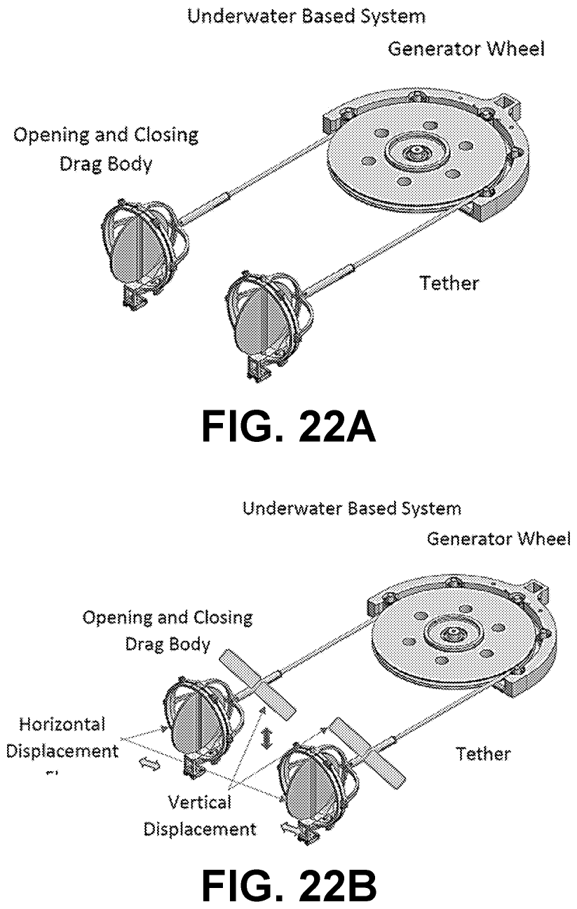

In one exemplary design for a MARINER or FLOSS illustrated in the examples of FIGS. 22A and 22B, an actuated flap can open and close thereby controlling the relevant surface area exposed to the flow (i.e., reference area, S_ref) and the resulting drag force generated. By controlling the position of the flap on the two drag bodies in the flow, it is possible to induce a flossing motion at incredibly turbulent, muddy, and low flow speeds which can then be used to generate power. The use of flaps also keeps the system volume the same and maintains the buoyancy of the drag bodies. Additionally, the flaps can also be used to control the horizontal direction of each drag body during flossing. By creating a slight skew angle, a resultant force can be created to force the drag bodies to maintain separation during flossing and reduce the chance of tether tangling. This effect can be achieved passively through different shaped flaps or actively via a control mechanism. Additional flaps can also be included to control the vertical direction of the drag bodies as illustrated in the example of FIG. 22B.

An example of the flap shape is to have a circular or rectangular asymmetric surface with one face smooth and the other face with a bulge like that of an airfoil. Using the working principles of airfoils, the flow around the flap will create a lift force acting on the bulging/curved surface. Based on the orientation of the drag bodies, the open flap will create an outward force resulting in passive separation of the body and tether in the flow. The design can also replace the use of tethers to connect the drag bodies for other physical structures like linear rails, tilting/rotating hinged arms that can pivot, and other engagements that can enable reciprocation. The mechanical energy generated due to the linear motion of the drag bodies can be converted to any other form of energy based on the need of the application for example, to generate power for electrical energy or using mechanical energy to conduct desalination in a water environment. The method of conversion of linear motion to usable power generation can be done by but is not restricted to the use of single/multiple pully wheels, or other methods of transmission for energy generation. This can be applied to any application underwater, on water, land, and air. The attitude of the drag bodies and tether in the water can be controlled by hydrodynamic manipulation causing resultant forces through surface deflection or via buoyancy control depending on the operating environment.

In some implementations, more than one drag body can be attached to each side of the tether. For example, one can be optimized to provide the maximum drag force, while the other can be used to control the path of the tether to avoid entanglement.

### Underwater (Single Drag Body):

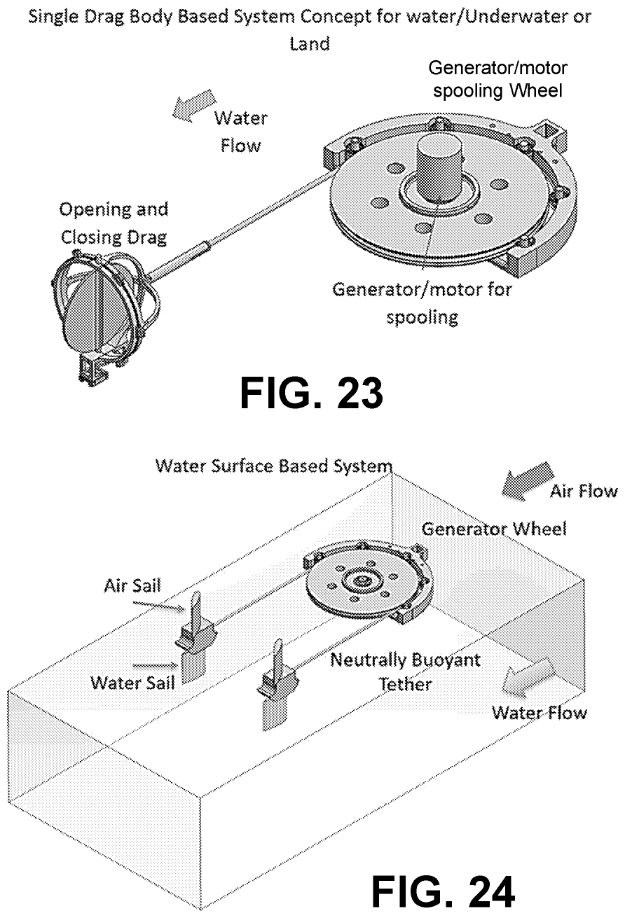

Additionally, the system can be adapted into a single drag body design with a generator and spool as illustrated in the example of FIG. 23. For this design case, the drag body reels out when the flap is closed (higher drag force) and generates power (power stroke). Once paid out, the flap is opened, and the body is reeled back in (reel-in stroke). Due to the reduced drag force with the opened flap, the energy consumed by spool motor is significantly less than the energy generated during spool-out. Thus, the net energy generation for this design will be positive. This application can be utilized in shallow and narrow water channels, where having two reciprocating bodies might be difficult.

### Water Surface (Two Drag Body):

Through testing, it was observed that the system initiates the reciprocation motion even while the bodies are partially submerged and on the surface in shallow water. As such the application case for such a design and system, extends to a surface-level state and submerged state of device operation. For water surface operation, the drag bodies float on the water surface. Oscillation/reciprocation can be achieved by having either a profile-changing or area-changing drag force surface affixed below the floating body, a drag sail system fixed above the body, or a combination of both as illustrated in the example of FIG. 24. The profile-changing drag surface can either rotate about the horizontal axis or the vertical axis. The drag surface itself can be, but is not limited to, either a symmetric/asymmetric airfoil or a flat disc. The area-changing surface can be, e.g., an inflating deflating bladder, an opening-closing umbrella shape, or an area-changing system. The sail-based system operates based on airflow and resembles conventional sails. This gives the system the ability to harness water currents and or air currents to generate power in surface-level shallow water, muddy water, turbulent flow, and deeper underwater currents and drastically extends the versatility of the system for all current flow applications. The design can also replace the use of tethers to connect the drag bodies for other physical structures like linear rails, tilting/rotating hinged arms that can pivot, and other engagements that can enable reciprocation.

### Water Surface (Single Drag Body):

A similar application of the underwater single body as described above can be applied to the water surface reciprocating/oscillating system along with the described water and air drag surfaces.

### Drum-Based Drag Body FLOSS/MARINER System:

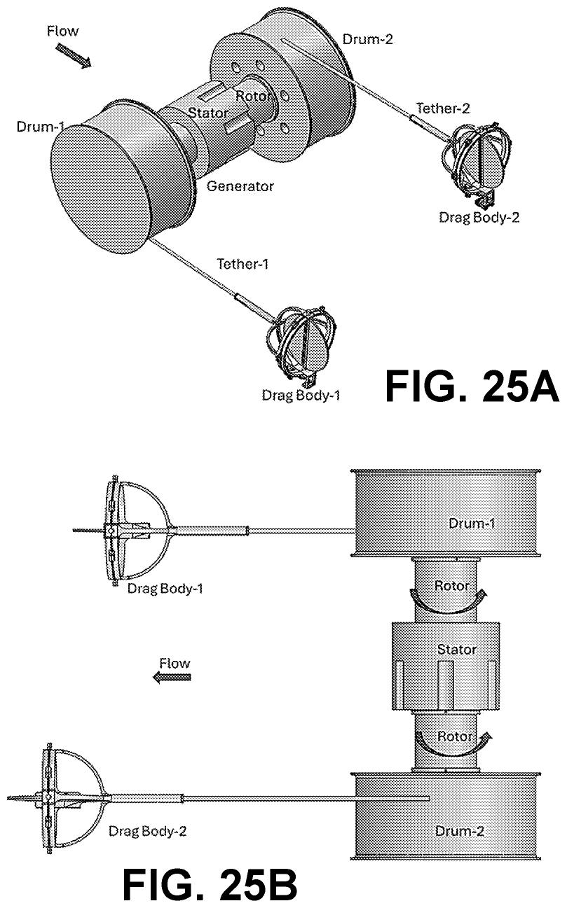

The FLOSS/MARINER system utilizes two circular drums, each fitted with a drag body and a tether as illustrated in FIGS. 25A and 25B. The two drums are attached to the rotor shaft of a generator, with the stator of the generator being held in place. Both the drums and rotor shaft are coupled and spin in the same direction. The respective tethers of the two drag bodies are wound around the drums such that during clockwise rotation, one drag body spools in while the other spools out. Reversing the rotation reverses the spooling direction of the drag bodies. This configuration allows for both drag bodies to have independent tethers, which can be used to actuate the respective drag body surfaces.

### Land and Air (Single, Two, Drag Body)

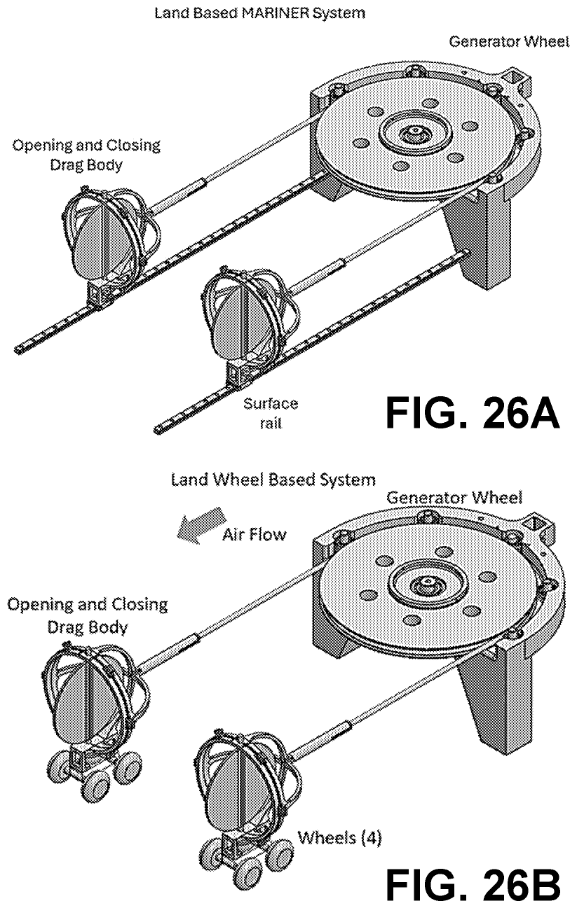

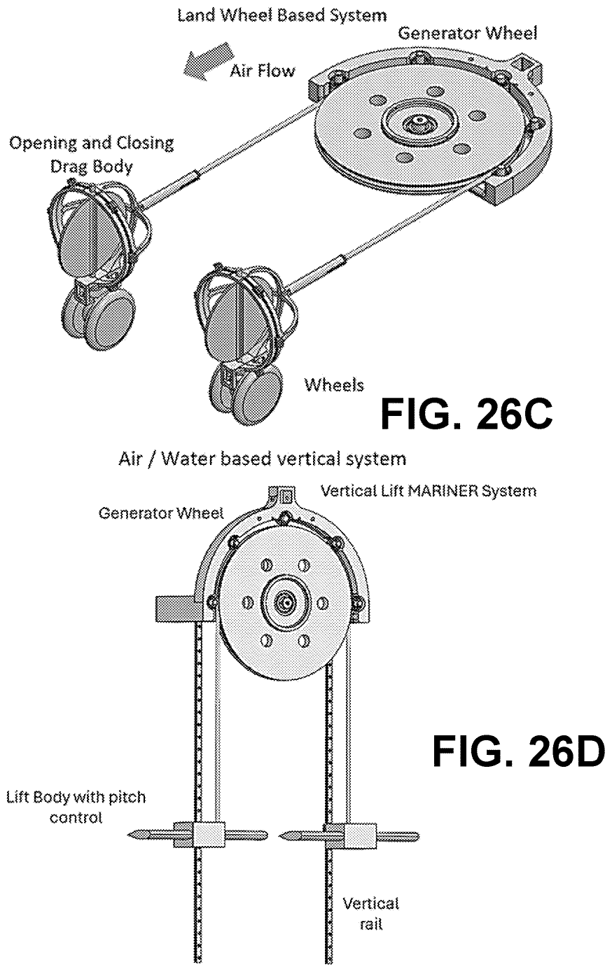

The MARINER concept can also easily be utilized for aerial and land applications as illustrated in the examples of FIGS. 26A-26C. Taking the drag-based reciprocating concept a system that has the ability to change drag and enable reciprocation will generate power. For land, an interconnected land sail can be utilized to harness wind. This would operate similarly to the dual or single drag body. The two oscillating bodies would traverse on low friction parallel rails with large variable drag sails or be adapted with wheels, or other methods for allowing land traversal. This would allow for operation and energy extraction in low wind speed environments with an extremely low cut-in speed. For air, an application using variable drag force generating kites or buoyant balloons can be used to generate flossing.

Additionally, a vertical flosser can be created either in air or water where a lift/drag change mechanism can be used for vertical flossing and energy generation as illustrated in the example of FIG. 26D. Here, a two-wing system would move vertically on their respective rails by changing the lift generated in the flow. Similar to the drag-based horizontal flossing method, this vertical flossing system would harness lift to generate power. Multiple tethers can also be deployed along a long horizontal or vertical pole—each driving a separate generator, or driving the same generator via a clutch or gearing.

### Multi Drag Body FLOSS/MARINER System:

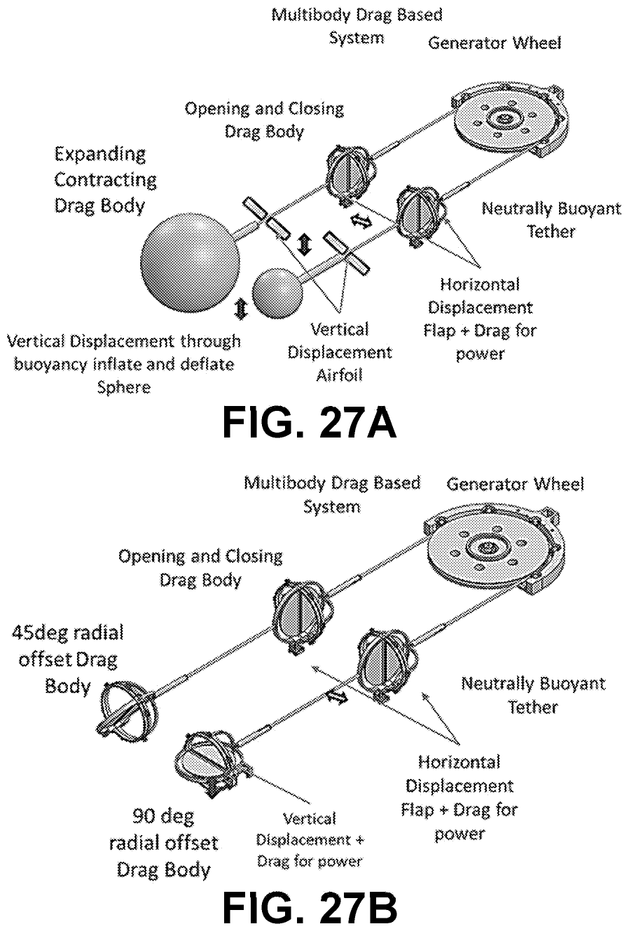

The FLOSS/MARINER system can be fitted with more than two drag bodies depending on the application and location of deployment in order to harness the maximum power from the flow as illustrated in the examples of FIGS. 27A and 27B. This orientation can be added to all applications of FLOSS/MARINER, be it land, air, water, or water surface versions. Each tether can hold n number (multiple) of drag bodies, either being the same shape in the same orientation, different orientations concerning each other, or with different shapes as shown in FIG. 27A. They may be of the same volume, area, size, or different in volume, area, and size, depending on the design parameters. An example case is if there are two flap drag bodies that are offset radially about the tether axis by 90 degrees, so that one deflects vertically and the other horizontally as shown in FIG. 27B. Depending on the design case, any degree of set can be used and any stagger distance between the drag bodies along the tether can be selected. Additionally, for the FLOSS/MARINER system, the number of drag bodies on each tether does not need to be the same. One tether section may hold more drag bodies than the adjacent tether section on the same system.

### Multi-Tether FLOSS/MARINER System:

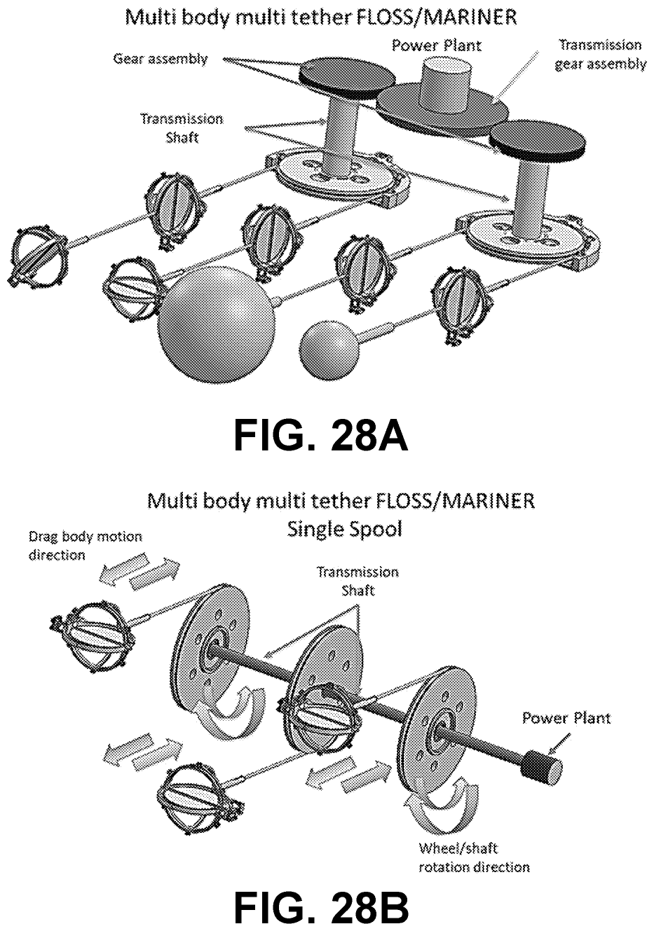

The FLOSS/MARINER system can have multiple tethers with drag bodies in a single system all oscillation to generate power with the transmission from their respective reciprocation being transferred to the same power plant like a generator or to multiple coupled power plants that act as a single system to generate power, energy be it mechanical or electrical in nature as illustrated in the examples of FIGS. 28A and 28B. Similar to how a V6 engine has 6 pistons with a power stroke that turns a single crank shaft to send power, think of each tether with drag bodies on it as a piston that sends power to the system. Thus, multiple combinations of tether and drag bodies, interconnected via mechanical means like different gears, can be united to create a single multi-tether drag body power generation system as shown in FIG. 28A.

For the design in FIG. 28B, the FLOSS/MARINER system has multiple tethers, a drag body and wheels connected to a transmission shaft. The shaft is connected to the power plant. Note that the tether can have more than one drag body attached to it. The tether subsystems are staggered along the transmission shaft. Similar to pistons on an engine, the drag bodies alternate between opening and closing so that every other system is paying out while the other is paying in. Thus, multiple power strokes can be obtained to maximize power. Multiple tethers can also be deployed along a long vertical pole (each one below the other).

### FLOSS/MARINER Omni Direction Control:

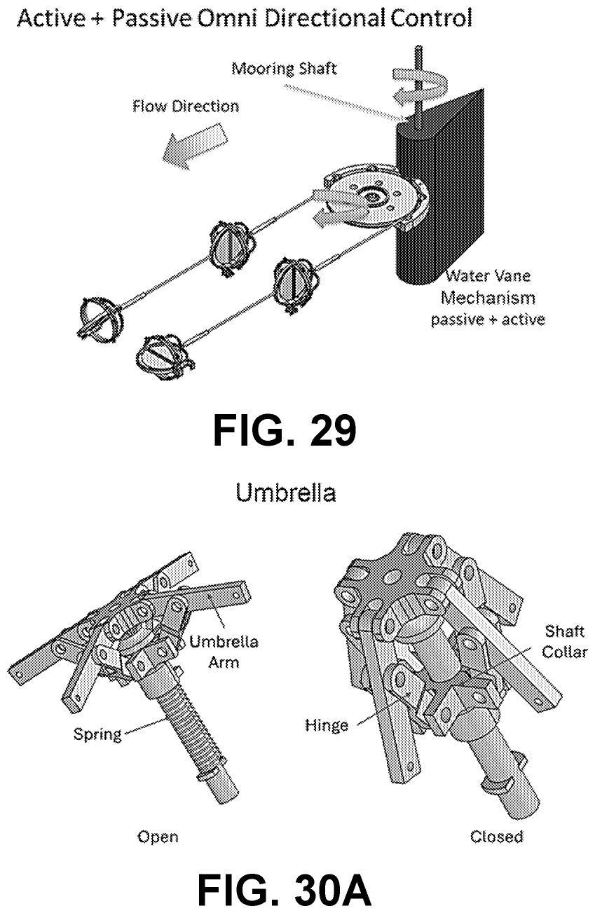

Water Vane Mechanism. It is a passive+active mechanism that can either actuate the rotation or passively keep the system pointing in the optimum direction, similar to a weather vane as shown in FIG. 29.

### Drag Body Examples:

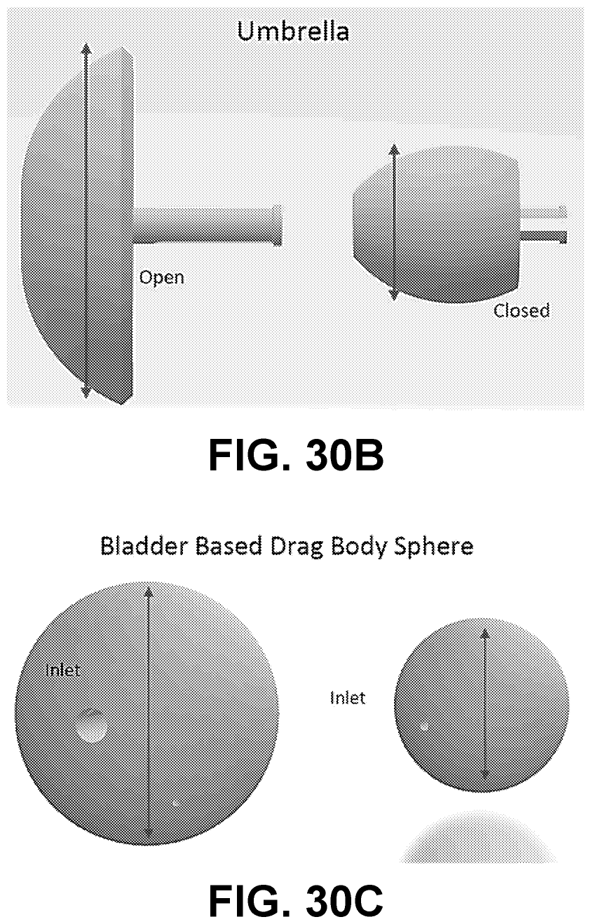

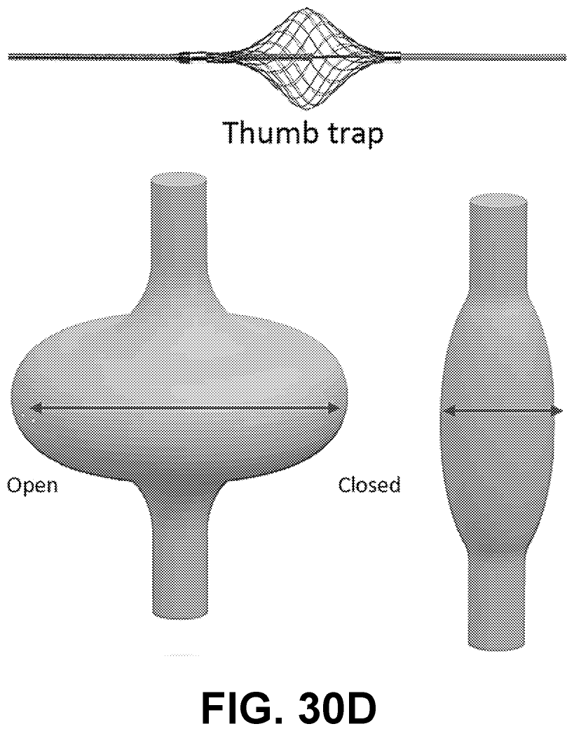

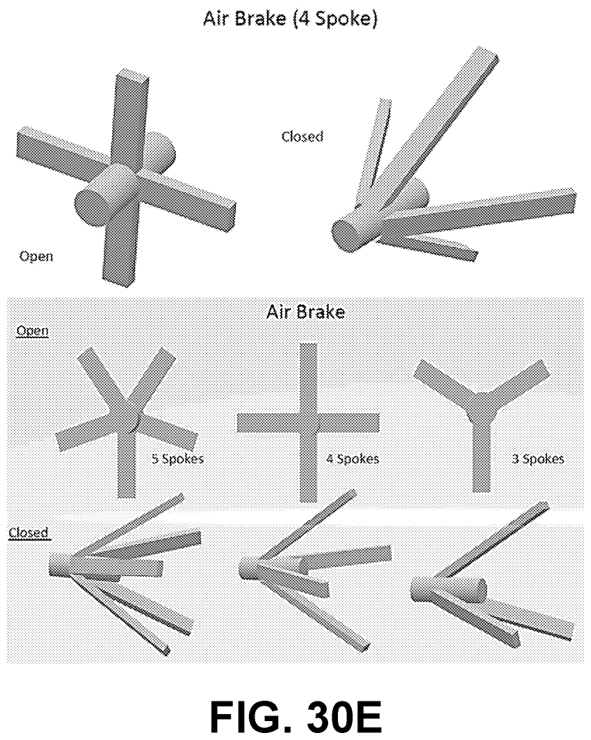

Some examples of drag bodies include those that change the surface area concerning drag as illustrated in FIGS. 30A-30E. These area-changing drag bodies including those that can achieve a similar result by changing the volume, change surface area to effect a change in drag force being generated. One differentiating property between area-changing and volume-changing is, that area-changing bodies can maintain buoyancy while changing area, while volume-changing drag bodies change the buoyancy. Some inspired design examples of area and volume changers are Umbrella drag bodies (FIGS. 5, 30A and 30B), air brake inspired (FIG. 30E with 2,3,4,5 . . . n spokes), thumb trap (FIGS. 4 and 30D), bladder-based inflatable spheres (FIGS. 4 and 30C), etc. The actuation/activation of these drag bodies/surfaces can be accomplished by, but not limited to, hydraulic, pneumatic, electrical, or mechanical actuators or other actuation mechanisms. As mentioned above, variable volume drag bodies undergo a change in buoyancy, which must be accounted for, but which can be also exploited to help keep separation between the two halves of the tether.

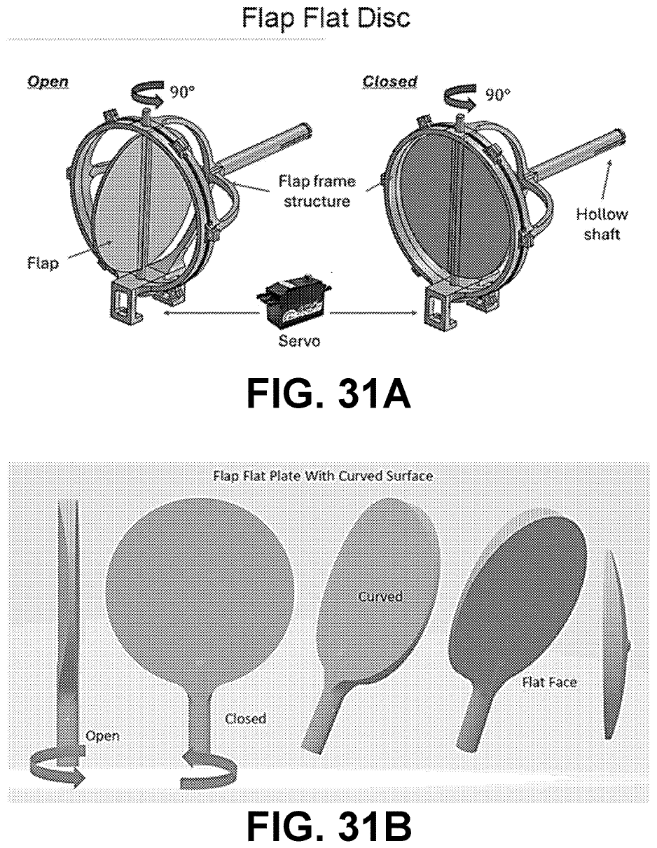

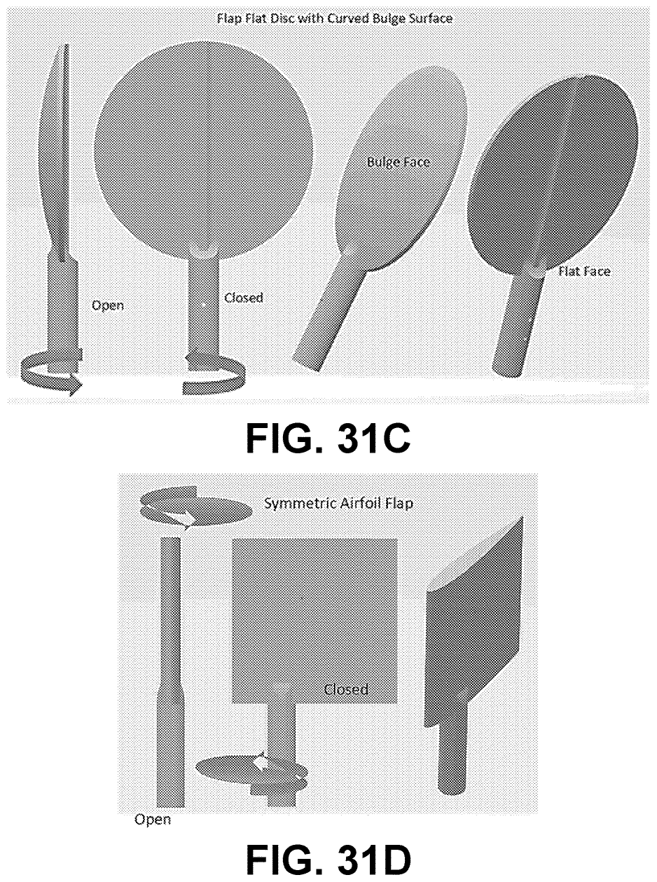

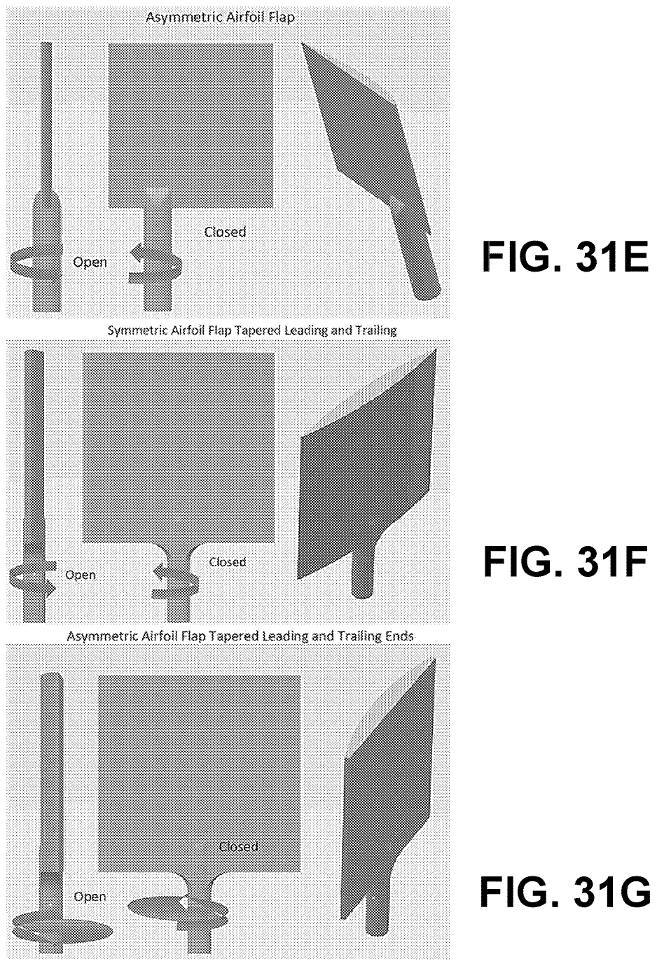

An additional example of drag bodies includes those that change their profile with respect to oncoming fluid flow which results in a change in force as illustrated in the examples of FIGS. 31A-31G. Profile-changing drag bodies can be symmetric or asymmetric in design. They maintain volume and buoyancy during profile transition. An example is the flap based design (FIG. 31A) that changes the effective relevant surface area exposed to the flow (e.g., reference area, S_ref) to achieve drag change by changing the angle of attack of the flap with respect to the oncoming flow. Some inspired design examples of profile changers includes Flat Disc, Asymmetric disc, Symmetric airfoil with and without tapered ends (FIGS. 31D and 31F), Asymmetric Airfoil with and without tapered ends (FIGS. 31E and 31G), disc with curved surface (FIG. 31B), curved bulged surface (FIG. 31C), etc. The actuation/activation of these drag bodies/surfaces can be done by any means, including but not limited to, hydraulic, pneumatic, electrical, or mechanical.

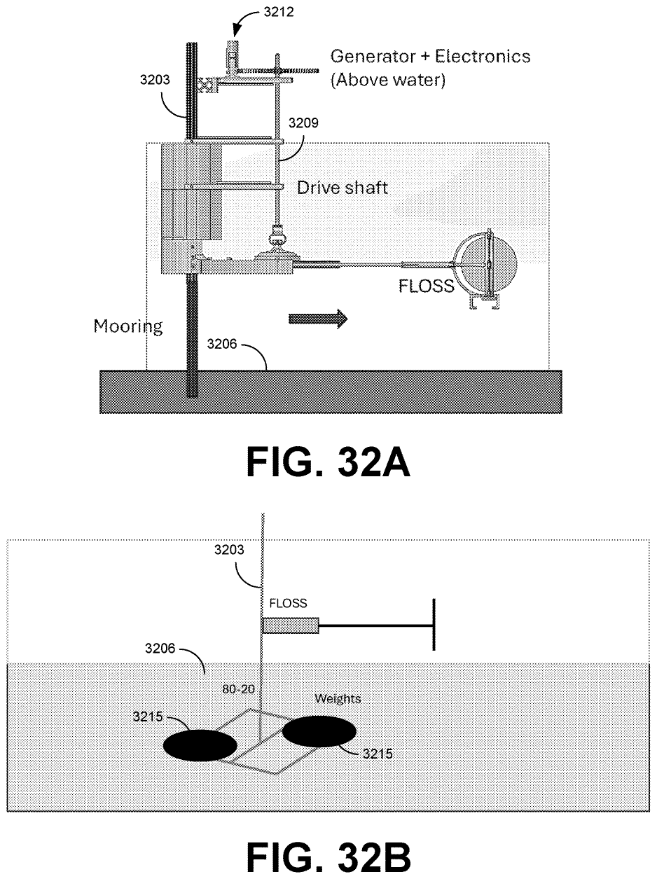

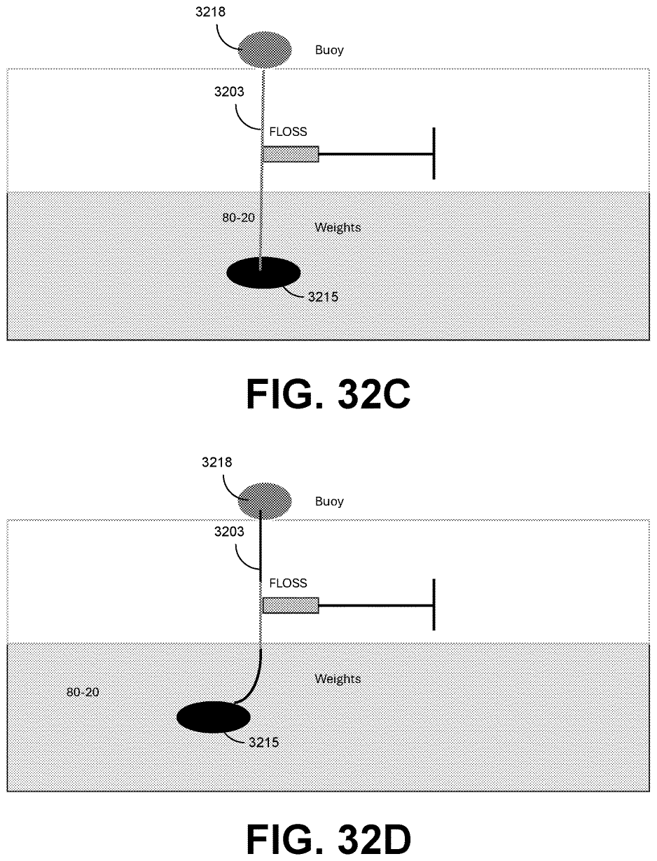

Referring next to FIG. 32A, shown is an example of a mooring setup for FLOSS deployment. The FLOSS can be mounted to a mooring shaft (pier or post) 3203 secured in the waterbed or seafloor 3206. A drive shaft 3209 can couple the generator wheel of the energy converter to the generator 3212 positioned above the water. In some implementations, the generator 3212 can be configured for underwater operation allowing it to be mounted underwater at the generator wheel as illustrated in FIG. 23. FIGS. 32B-32D illustrate alternative mooring setups. For example, in FIG. 32B the mooring shaft 3203 can be supported on the water bed or seafloor 3206 and held in position by weights 3215 (e.g., sandbags, stones, concrete, etc.). This configuration allows the mooring shaft 3203 to be mobile and adjustable to changes in demand or flow. In FIG. 32C, the mooring shaft 3203 can be supported at an upper end by a buoy 3218 and weighted as a lower end by a weight 3215, with the FLOSS supported by the mooring shaft 3203. In FIG. 32D, the mooring shaft 3203 can be flexible allowing it to shift with the current flow and tides. Again, the mooring shaft 3203 can be supported at an upper end by a buoy 3218 and weighted as a lower end by a weight 3215, with the FLOSS supported by the mooring shaft 3203 as shown. As currents or tides change, the mooring shaft and FLOSS can shift to adjust for the changes.

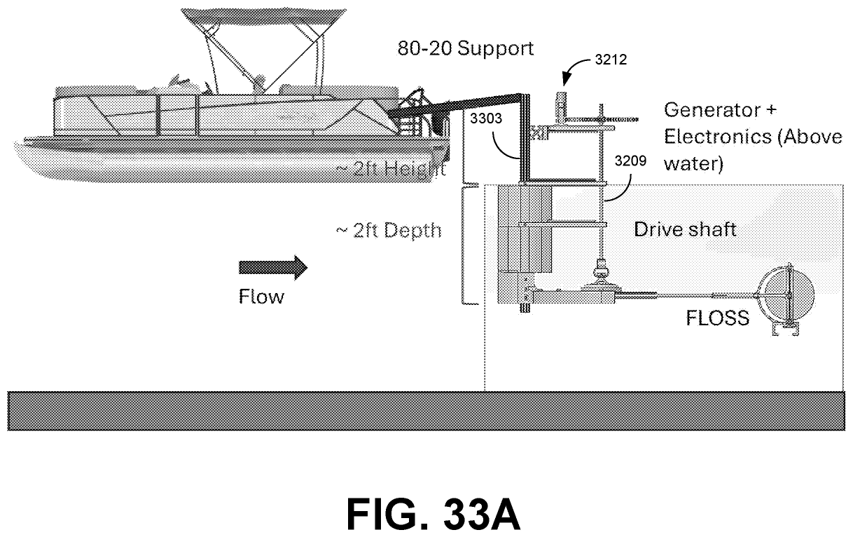

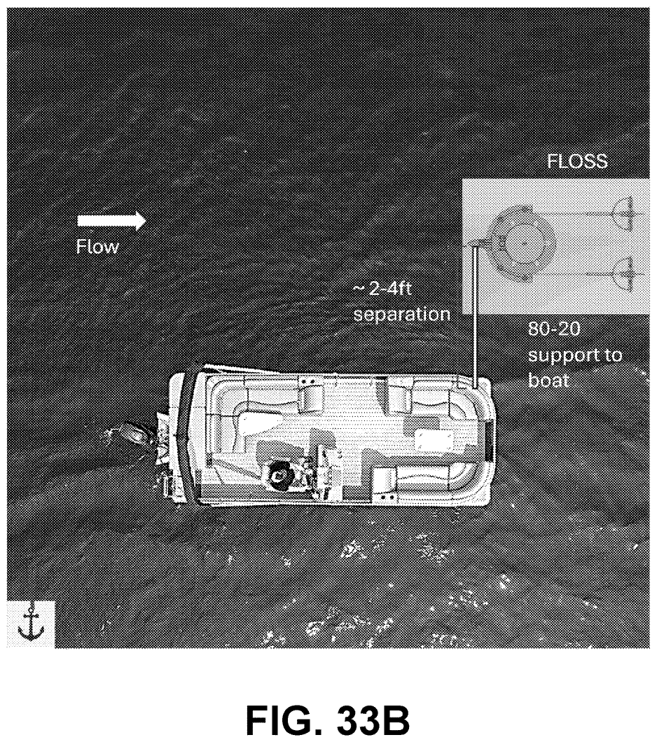

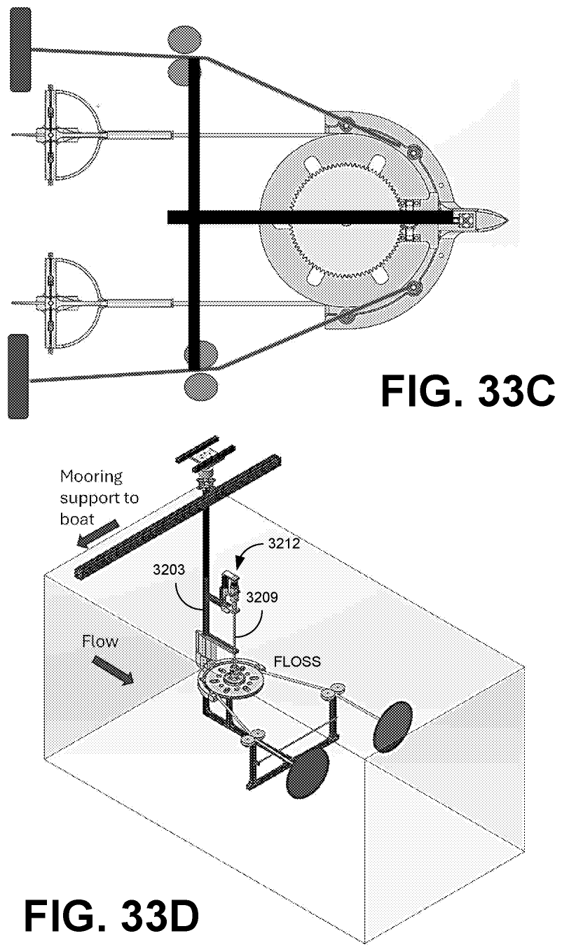

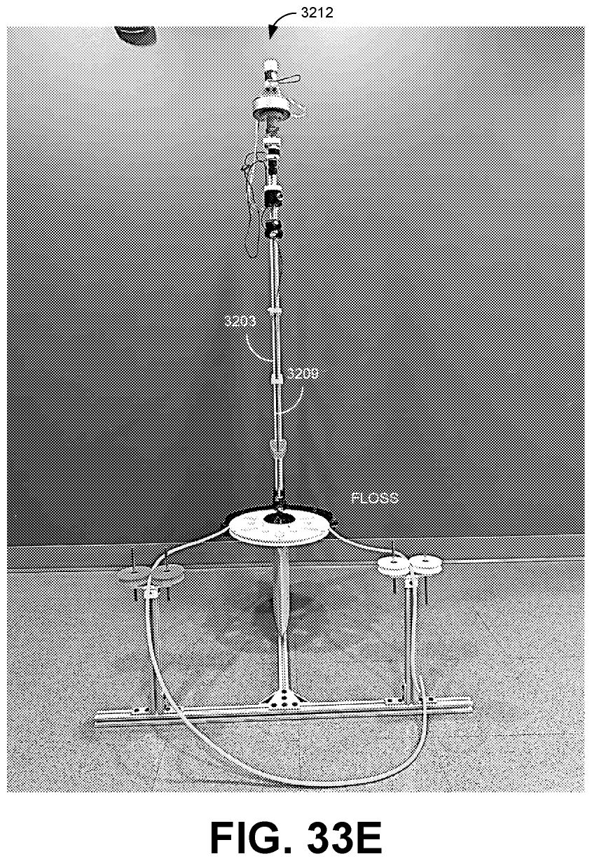

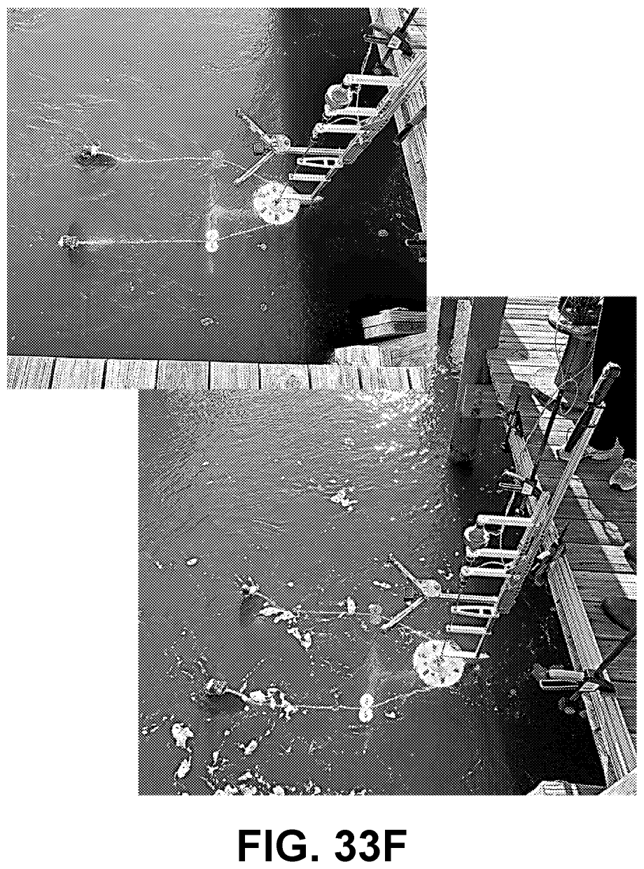

The FLOSS can also be deployed from a vessel (e.g., a boat) as illustrated in FIGS. 33A-33D. As shown in FIG. 33A, a support can extend from the vessel to support a mooring shaft 3303 to which the FLOSS is attached. The mooring shaft 3303 extends below the water surface allowing the FLOSS to be submerged. As in FIG. 32A, the drive shaft 3209 can couple the generator wheel of the energy converter to the generator 3212 positioned above the water. The generator 3212 can be configured for submerged operation allowing it to be mounted underwater at the generator wheel as illustrated in FIG. 23. The FLOSS can be located off to one side of the vessel (e.g., the starboard side as shown in FIG. 33B), but this can be determined based upon the design of the vessel and the current flow, including forward or aft of the vessel. FIG. 33C is a bottom view and FIG. 33D is a perspective view of the FLOSS mounting. As illustrated, the framework can include guides (e.g., pulleys) to direct the tether to ensure that the drag bodies remain separated during operation. FIG. 33E is an image of a fabricated FLOSS showing the arrangement depicted in FIGS. 33A-33D and FIG. 33F includes images of the fabricated FLOSS during testing showing the effectiveness of the design under low flow conditions. The design can be utilized for both vessel and mooring deployments.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Therefore, at least the following is claimed:

1. A reciprocating oscillating energy harvester, comprising:
an energy converter;
a tether engaged with the energy converter; and
a drag body coupled to an end of the tether, the drag body configured to adjust force applied to the tether by changing surface area or profile of the drag body within a fluid flow, where the energy converter oscillates in response to variation of the surface area or profile of the drag body.

2. The reciprocating oscillating energy harvester of claim 1, comprising a second drag body coupled to a second end of the tether.

3. The reciprocating oscillating energy harvester of claim 1, wherein the energy converter comprises a generator wheel engaged with the tether.

4. The reciprocating oscillating energy harvester of claim 1, wherein the drag body comprises a variable profile body.

5. The reciprocating oscillating energy harvester of claim 4, wherein the drag body comprises a flap disc.

6. The reciprocating oscillating energy harvester of claim 4, wherein the drag body comprises an air foil or sail.

7. The reciprocating oscillating energy harvester of claim 1, wherein the drag body comprises a variable volume body.

8. The reciprocating oscillating energy harvester of claim 7, wherein the drag body comprises a conical umbrella.

9. The reciprocating oscillating energy harvester of claim 1, comprising a second drag body coupled along a length of the tether.

10. The reciprocating oscillating energy harvester of claim 9, wherein the tether is engaged with a generator wheel of the energy converter and the drag bodies are coupled to the tether on opposite sides of the generator wheel.

11. The reciprocating oscillating energy harvester of claim 10, the second drag body configured to alternate force applied to the tether with the force applied by the drag body.

12. The reciprocating oscillating energy harvester of claim 9, wherein the drag bodies are separated along the tether by a defined length.

13. The reciprocating oscillating energy harvester of claim 9, wherein the drag body and second drag body are both the same type of drag body.

14. The reciprocating oscillating energy harvester of claim 9, wherein the drag body and the second drag body are different types of drag bodies.

15. The reciprocating oscillating energy harvester of claim 1, wherein the energy converter comprises a drum engaged with the tether.

16. The reciprocating oscillating energy harvester of claim 1, comprising a generator mechanically coupled to the energy converter.

17. The reciprocating oscillating energy harvester of claim 16, wherein the generator is mechanically coupled to the energy converter via a drive shaft.

18. The reciprocating oscillating energy harvester of claim 17, wherein the energy converter is positioned for submerged operation and the generator is positioned for non-submerged operation.

19. The reciprocating oscillating energy harvester of claim 1, wherein the energy converter is supported by a mooring shaft.

20. The reciprocating oscillating energy harvester of claim 1, wherein the energy converter is supported by a vessel.
